(19) United States
(12) Patent Application Publication
(10) Pub. No.: US 2004/0068451 A1
(43) Pub. Date: Apr. 8, 2004

(54) Method and apparatus for managing demand and inventory

(75) Inventors: Edward C. Lenk, Orinda, CA (US); Sean E. Spector, Sherman Oaks, CA (US); Jung Suh, Santa Monica, CA (US)

Correspondence Address: David T. Yang, Morrison & Foerster LLP, 35th Floor, 555 W. 5th Street, Los Angeles, CA, 90013, US

(73) Assignee: GAMEFLY, INC., Santa Monica, CA (US)

(21) Appl. No.: 10/681,003

(22) Filed: Oct. 7, 2003

Related U.S. Application Data
(60) Provisional application No. 60/416,608, filed on Oct. 7, 2002.
(60) Provisional application No. 60/434,320, filed on Dec. 18, 2002.

(51) Int. Cl. G06F 17/60

(52) U.S. Cl. 705/28

(57) ABSTRACT

The present invention is directed to a method and system for managing the inventory level of, and the distribution of, electronic media rental units, including but not limited to videogame discs, musical compact disks, or movie VCD/DVDs. More specifically, preferred embodiments of the present invention forecasts future rental and sales demand for a given electronic media, such as a videogame, prior to the release of that electronic media to the general public. The forecast is based on the pre-release demand of the electronic media in that the future rental and sales demand is estimated from the rental and sales demand of previously released electronic media having similar pre-release demand. Furthermore, the preferred embodiments of the present invention allows registered members of a rental user group to keep rented units of the electronic media for a purchase price, which is dynamically controlled to minimize rental shortage and maximize profits.

This patent application claims priority from U.S. provisional application No. 60/416,608, titled “A Method and Apparatus to Manage Demand and Inventory,” filed on Oct. 7, 2002, and U.S. provisional application No. 60/434,320, titled “Method and Device to Manage Demand and Inventory,” filed on Dec. 18, 2002, both of which are hereby incorporated in their entirety by reference.

### BACKGROUND OF THE INVENTION

1. Field of the Invention

This invention relates to inventory control systems, and more specifically to dynamic inventory management to control demand and inventory to maximize profits in volatile markets.

2. Description of the Prior Art

Video game publishers release new video games to the public throughout the year. When a new game or title is first released to the public it is in high demand—consumers both buy and rent the game in large quantities. As time passes, demand for a game falls, often quite steeply, as consumer interest in purchase and renting a game declines, and as new game releases displace demand for previously released games. This pattern of demand presents challenges for video game rental services.

Rental outlets rarely place wholesale purchases for enough games to satisfy initial rental demand, creating a significant shortage of games for rent. If a rental outlet or service purchases enough units of a new game to satisfy initial rental demand, the service is left with too many units as demand falls, creating a “rental surplus.” To minimize the rental surplus, game rental services buy a small number of units relative to initial rental demand. In this way, as demand falls, the service is left with only a small rental surplus. Thus, initial consumer demand is unsatisfied and the ultimate commercial success of a release or title may not reach expectations.

What is needed is a technique for gauging pre-release demand and optimizing and controlling inventory levels and ongoing demand to maximize profits and minimize inventory.

### SUMMARY OF THE INVENTION

The present invention provides a technique for a game service to estimate opening demand for an upcoming release of an electronic entertainment item, to purchase an opening quantity of the new release, that is equal to, or a calculated amount below the level of opening demand. This minimizes the opening rental shortage and maximizes consumer satisfaction and market saturation.

As demand falls over time, the system increases sales of game units through dynamic price controls. In this way, inventory is continuously reduced after a game's release to balance inventory with falling demand surplus. This serves to minimize the rental surplus.

In another aspect of the present invention, opening demand is anticipated using price incentives and delivery priority to motivate consumers to become system subscribers and order games before the release date of the game.

In another aspect of the present invention, a game service may provide member subscribers and non-members an opportunity to trade-in electronic entertainment items for credit. The game service inventory control system may calculate the value of previously released electronic entertainment titles and publish a market list permitting member subscribers and nonmembers to trade previously released electronic entertainment titles to the service for monetary credit against current or future activities.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is block diagram of an electronic entertainment sales and rental system according to the present invention.

FIG. 2 is a flow chart according to the present invention.

FIG. 3 is a projected inventory control graph according to the present invention.

FIG. 4 is a projected demand graph according to the present invention.

FIG. 5 is a projected table of pre-release activity according to the present invention.

FIG. 6 is a projected table of game life activity according to the present invention.

FIG. 7 is a table of projected rental demand according to the present invention.

FIG. 8 is a table of projected sales of used games according to the present invention.

FIG. 9 is an updated projection table of rental demand according to the present invention.

FIG. 10 is an inventory reconciliation table according to the present invention.

FIG. 11 is a chart of inventory flows according to the present invention.

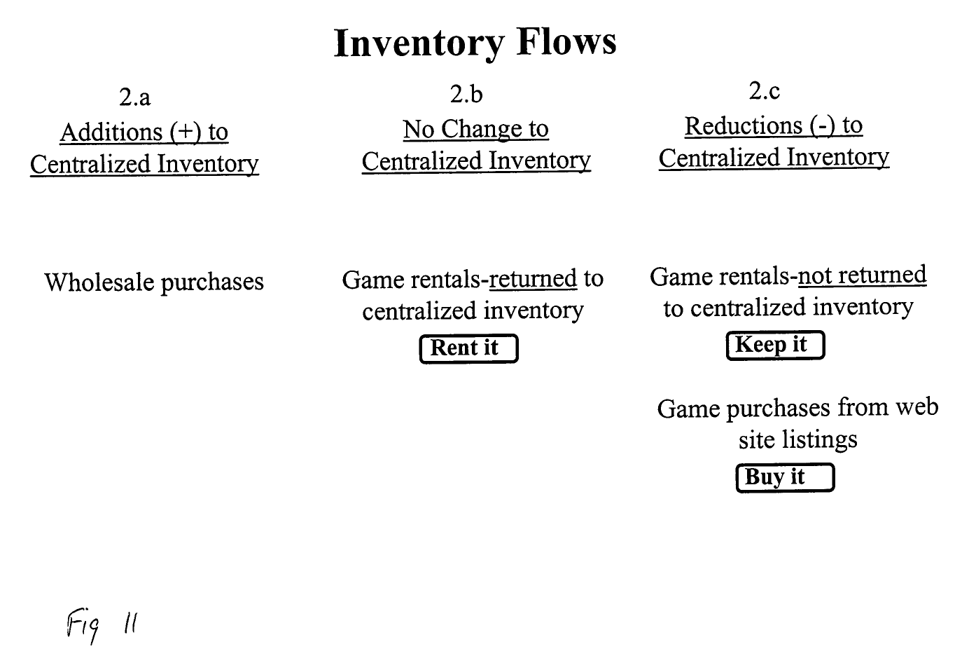

FIG. 12 is a chart of member services according to the present invention.

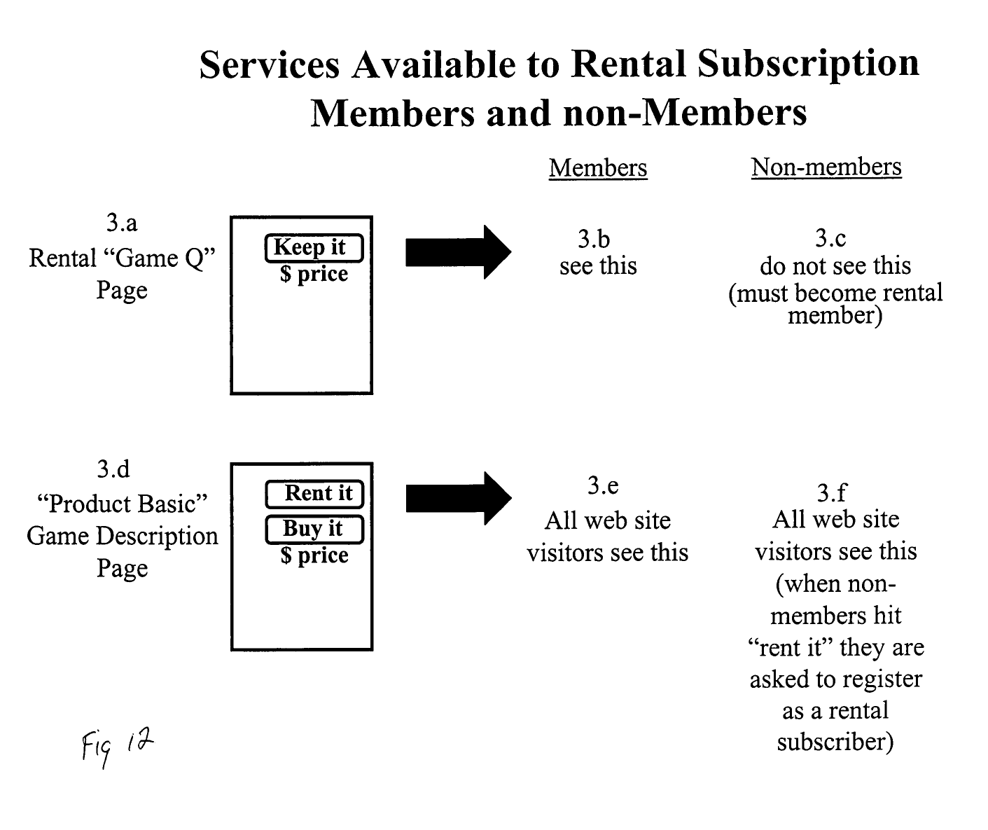

FIG. 13 is a graph of game rental demand according to the present invention.

FIG. 14 is a graph of game rental demand with demand shifting according to the present invention.

FIG. 15 is a chart of inventory management definitions according to the present invention.

FIG. 16 is a chart of demand versus inventory according to the present invention.

FIG. 17 is a chart of electronic entertainment item life cycle according to the present invention.

FIG. 18 is a chart of IMP inventory management according to the present invention.

FIG. 19 is a web page exemplar according to the present invention.

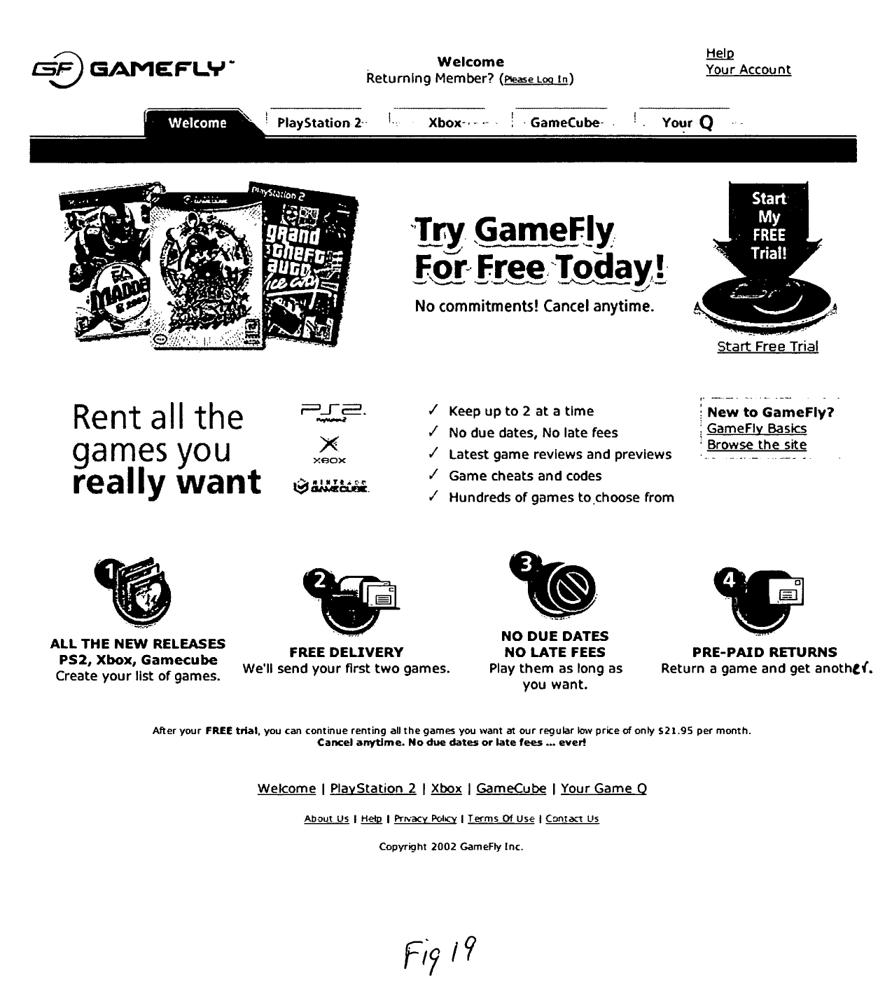

FIG. 20 is a web page exemplar according to the present invention.

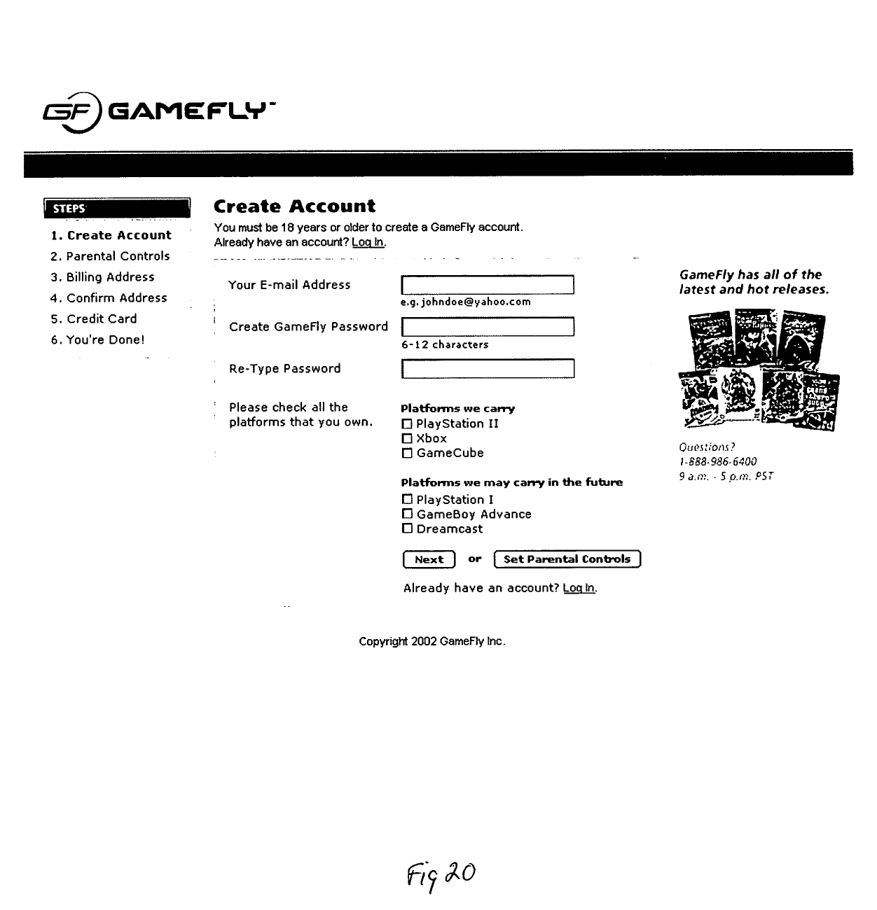

FIG. 21 is a web page exemplar according to the present invention.

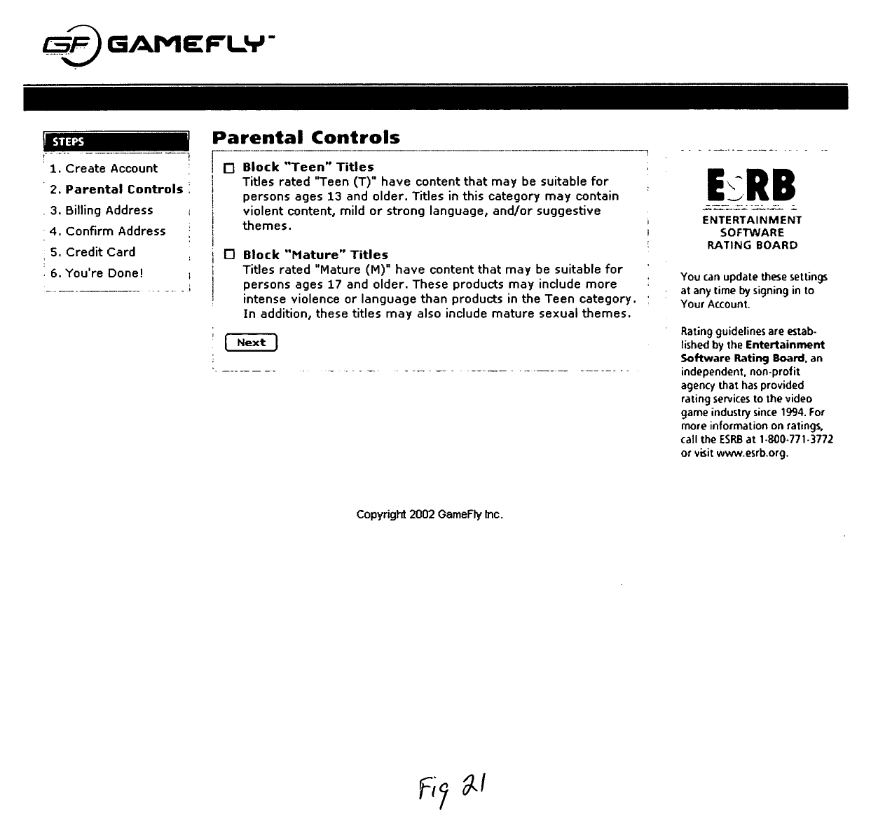

FIG. 22 is a web page exemplar according to the present invention.

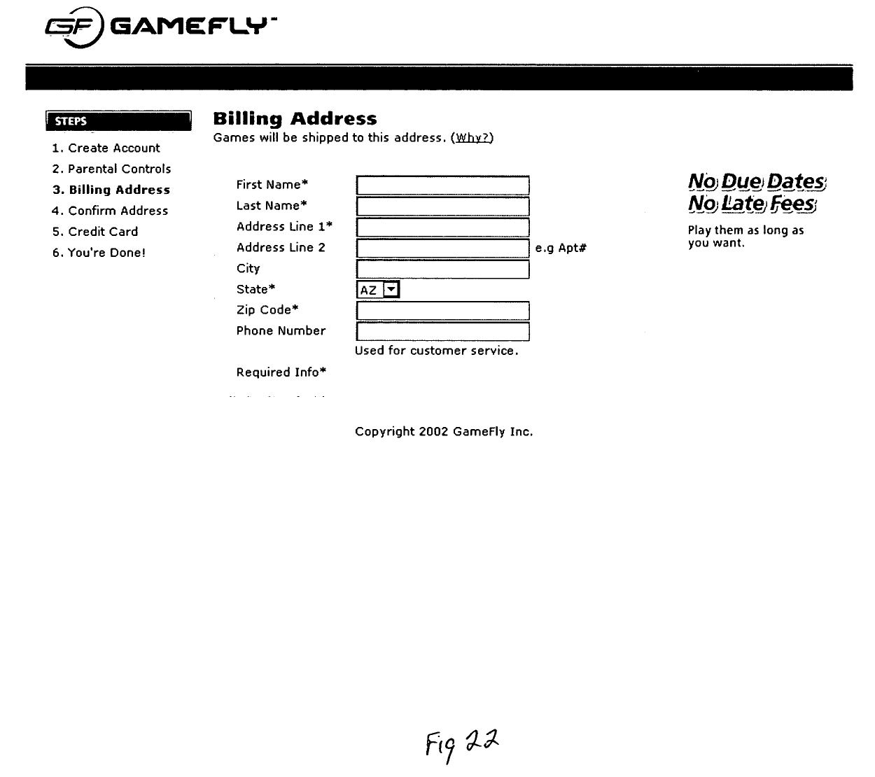

FIG. 23 is a web page exemplar according to the present invention.

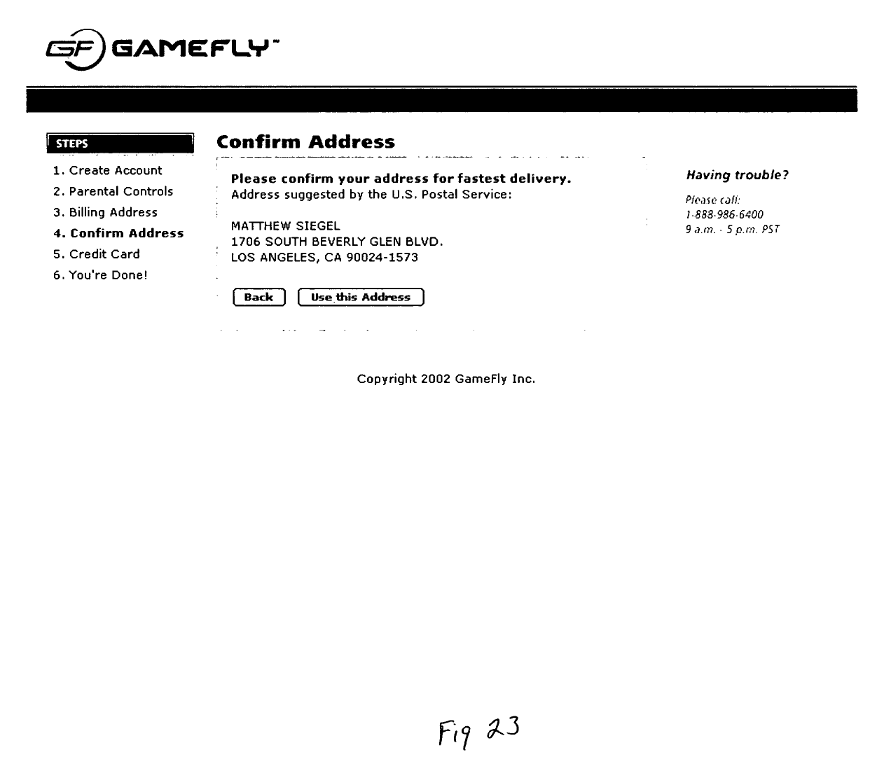

FIG. 24 is a web page exemplar according to the present invention.

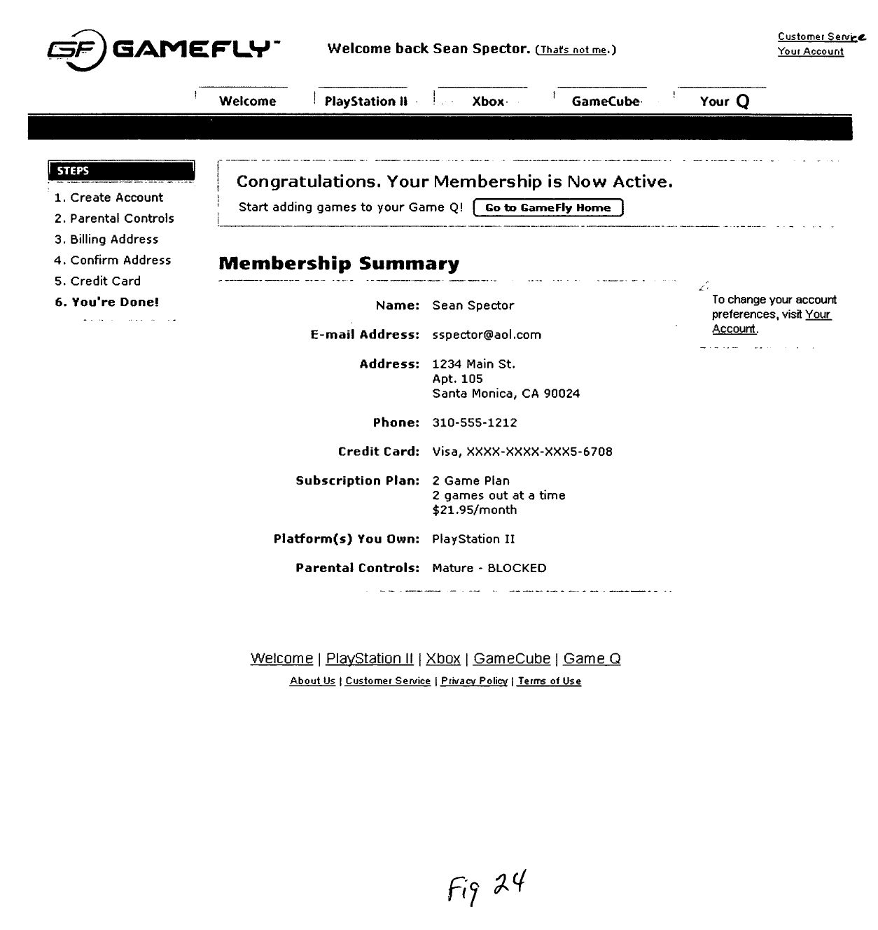

FIG. 25 is a web page exemplar according to the present invention.

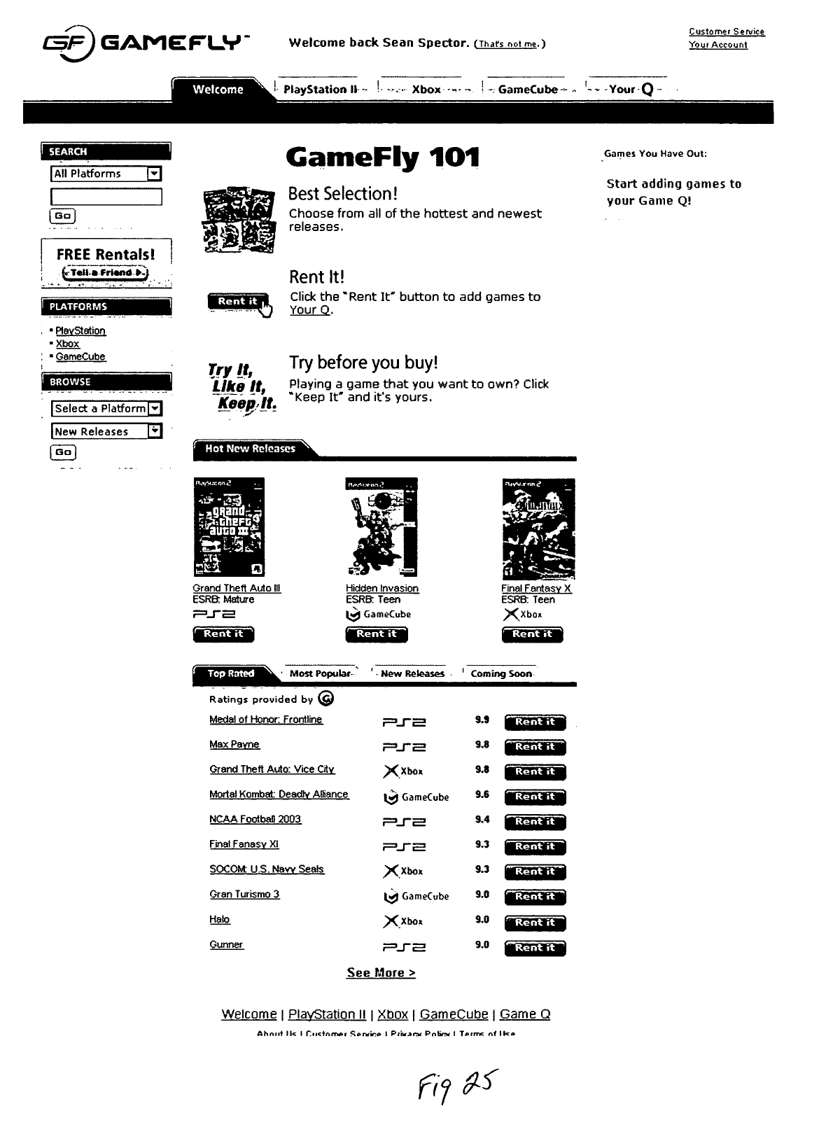

FIG. 26 is a web page exemplar according to the present invention.

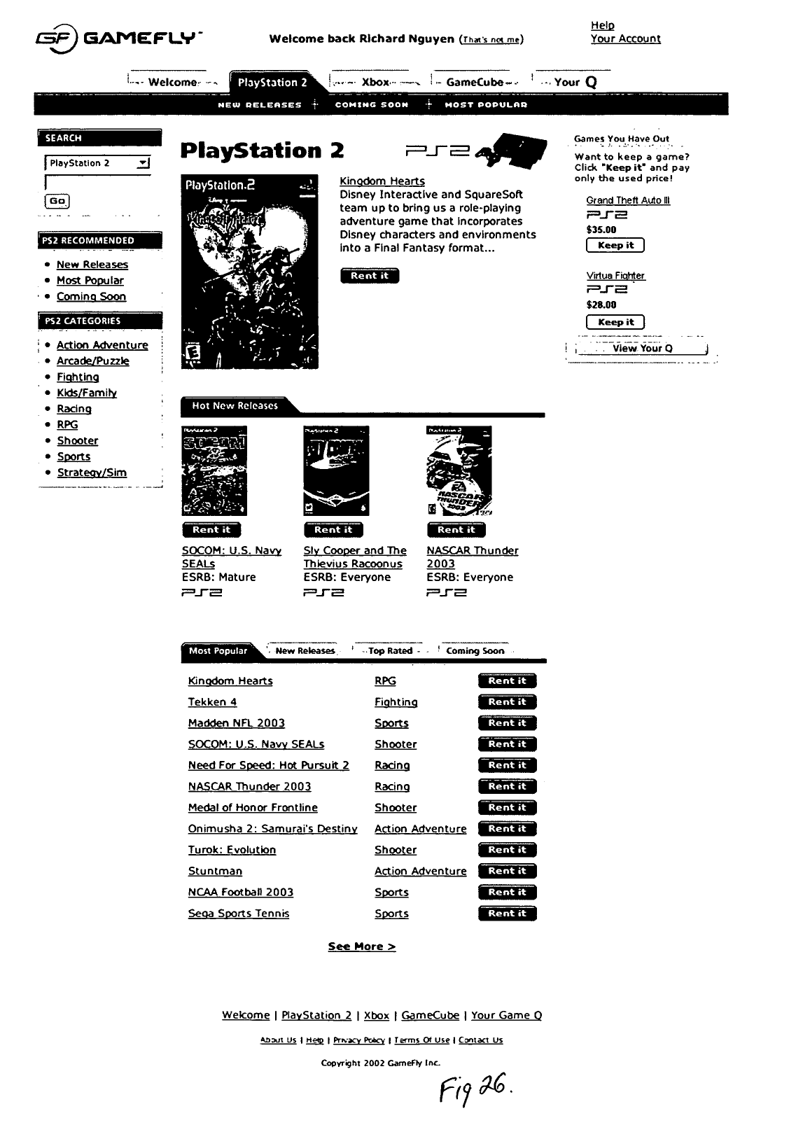

FIG. 27 is a web page exemplar according to the present invention.

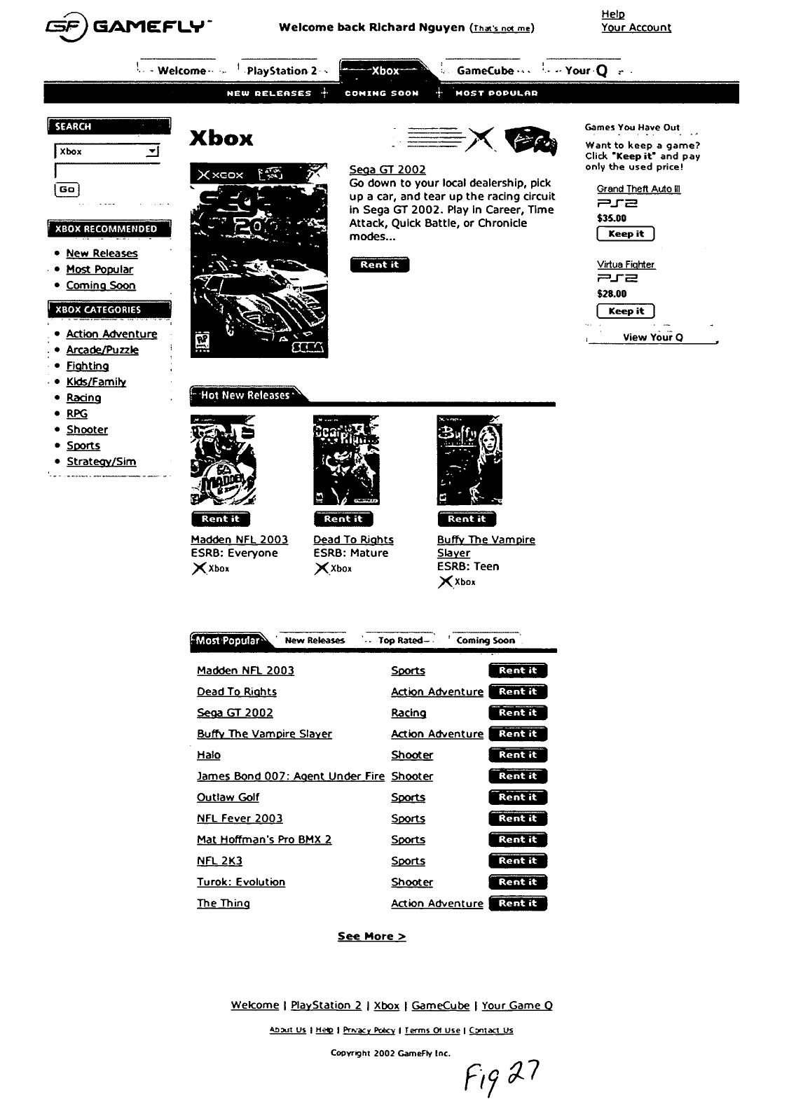

FIG. 28 is a web page exemplar according to the present invention.

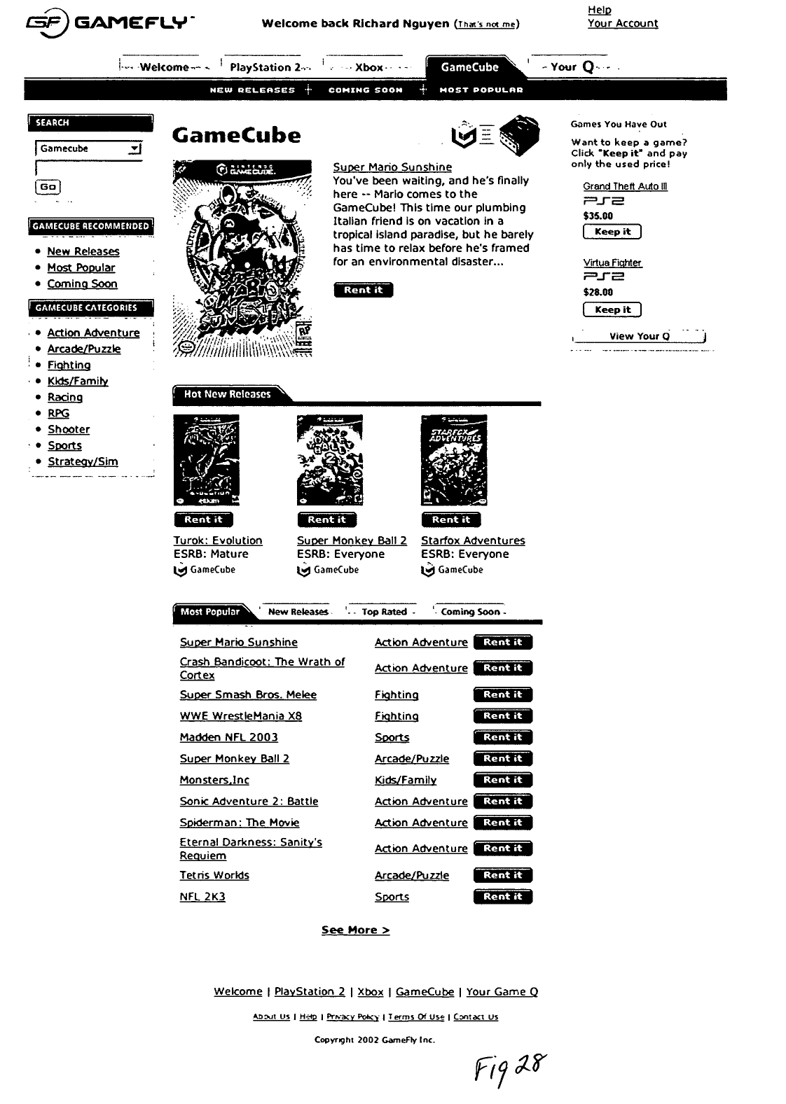

FIG. 29 is a web page exemplar according to the present invention.

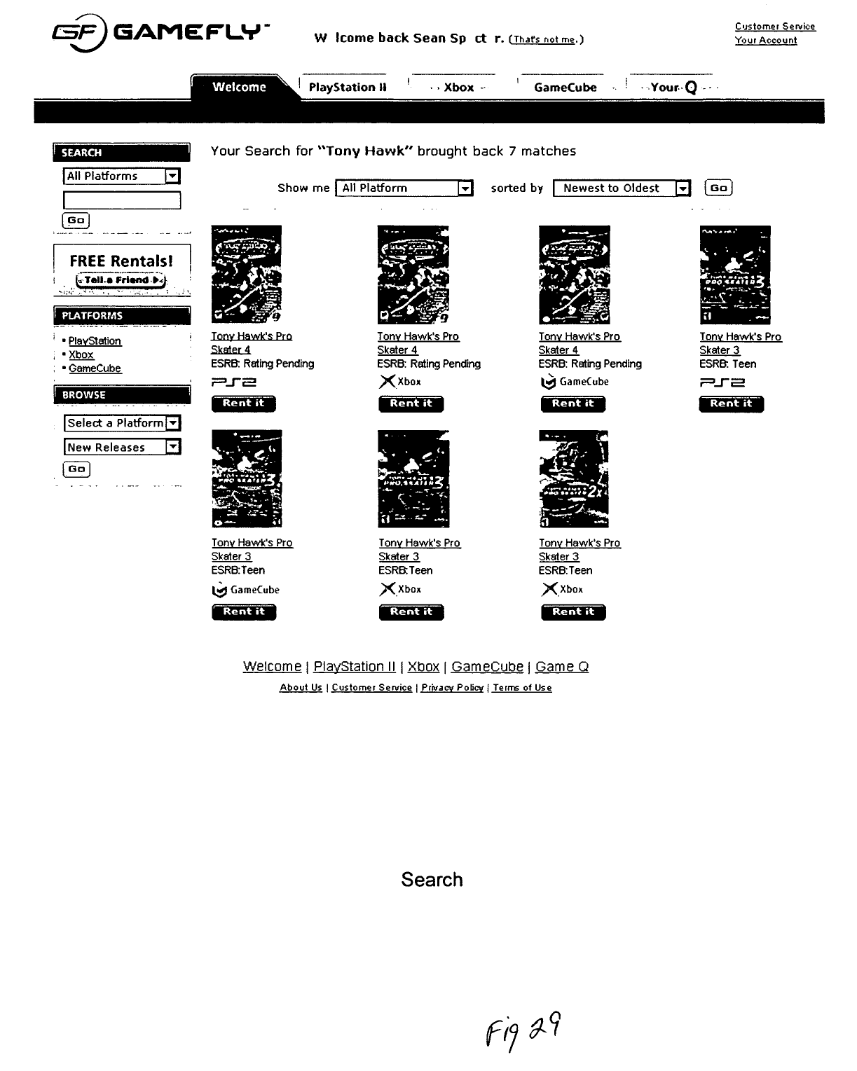

FIG. 30 is a web page exemplar according to the present invention.

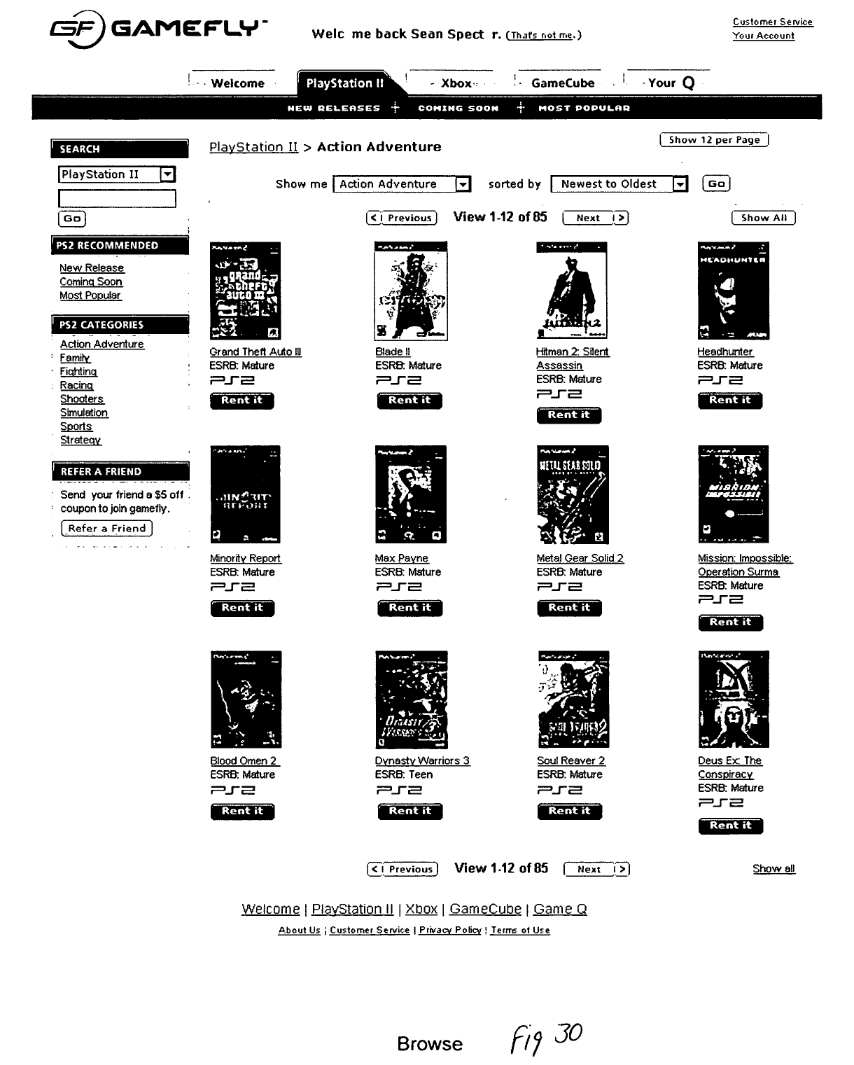

FIG. 31 is a product description web page exemplar according to the present invention.

FIG. 32 is a member Q web page exemplar according to the present invention.

FIG. 33 is a web page exemplar according to the present invention.

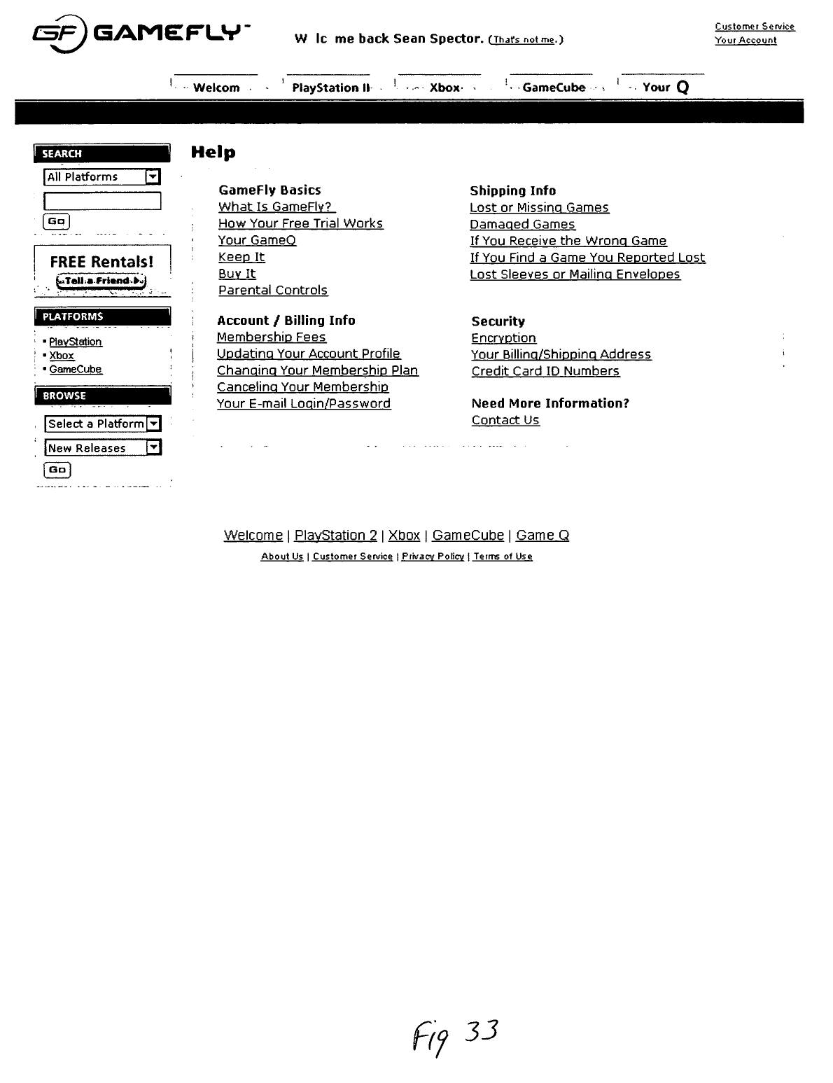

FIG. 34 is a web page exemplar according to the present invention.

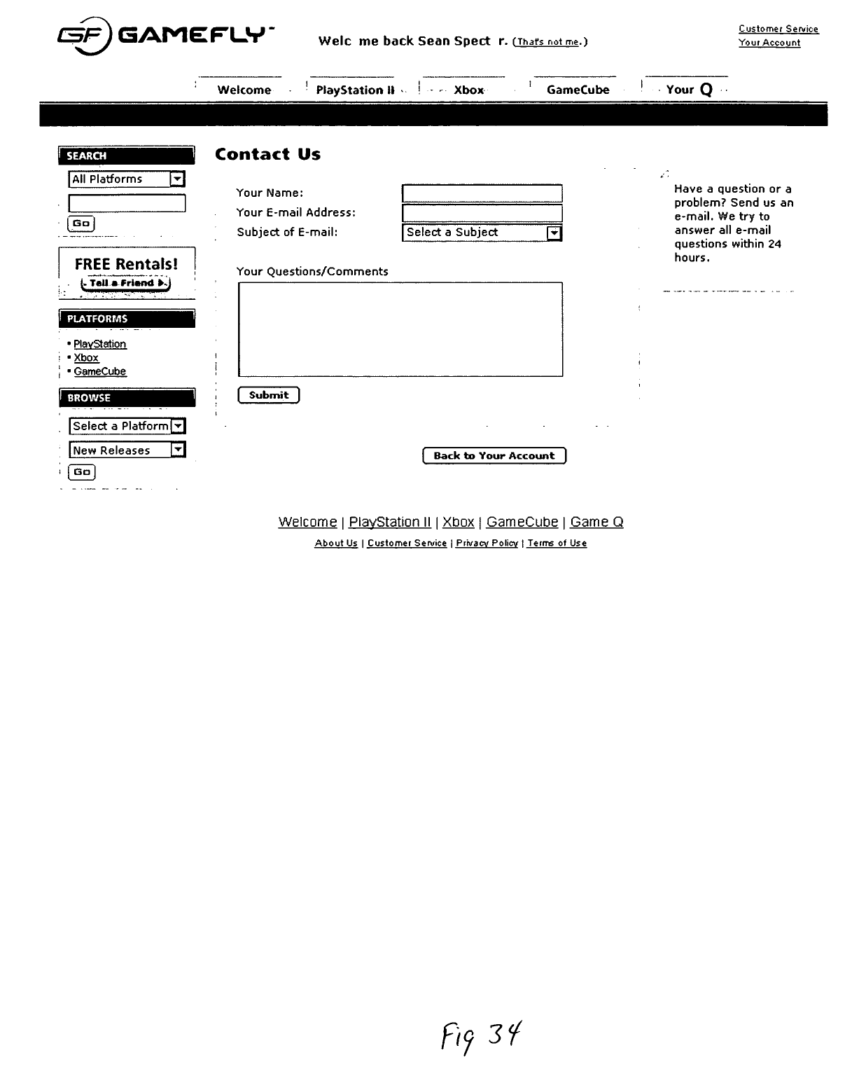

FIG. 35 is a web page exemplar according to the present invention.

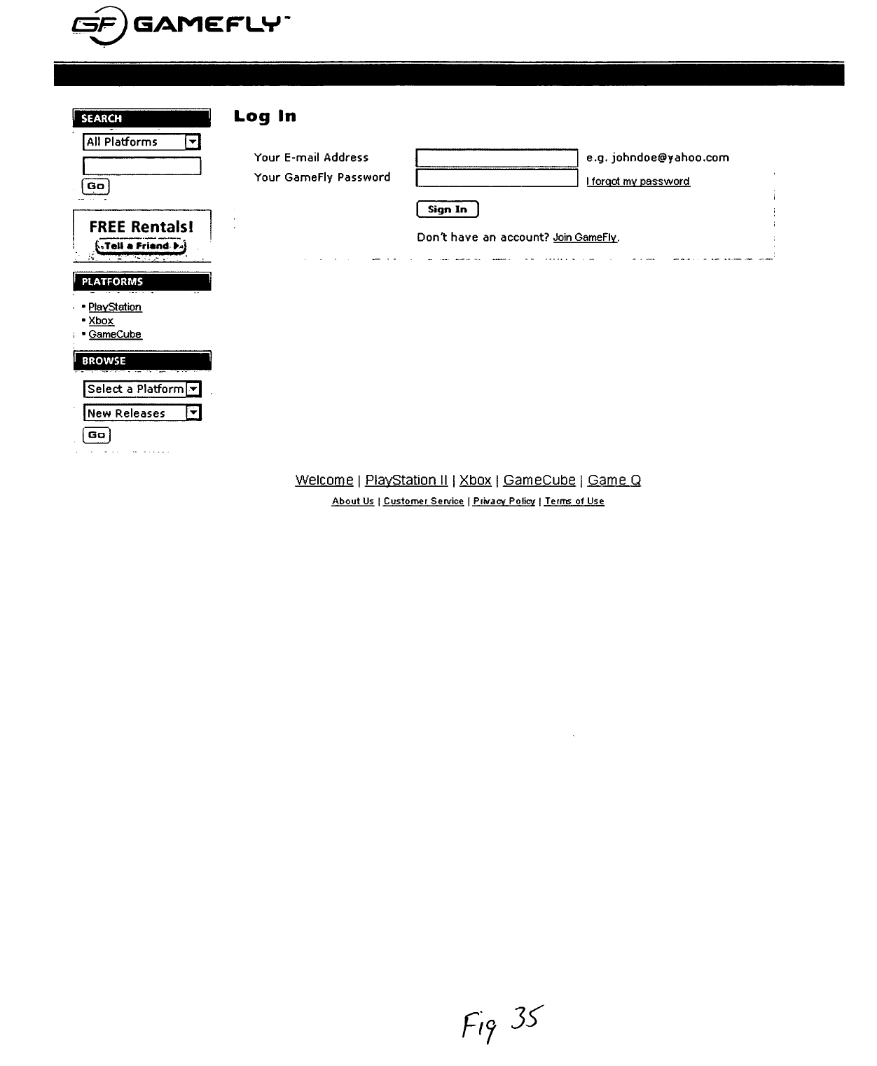

FIG. 36 is a web page exemplar according to the present invention.

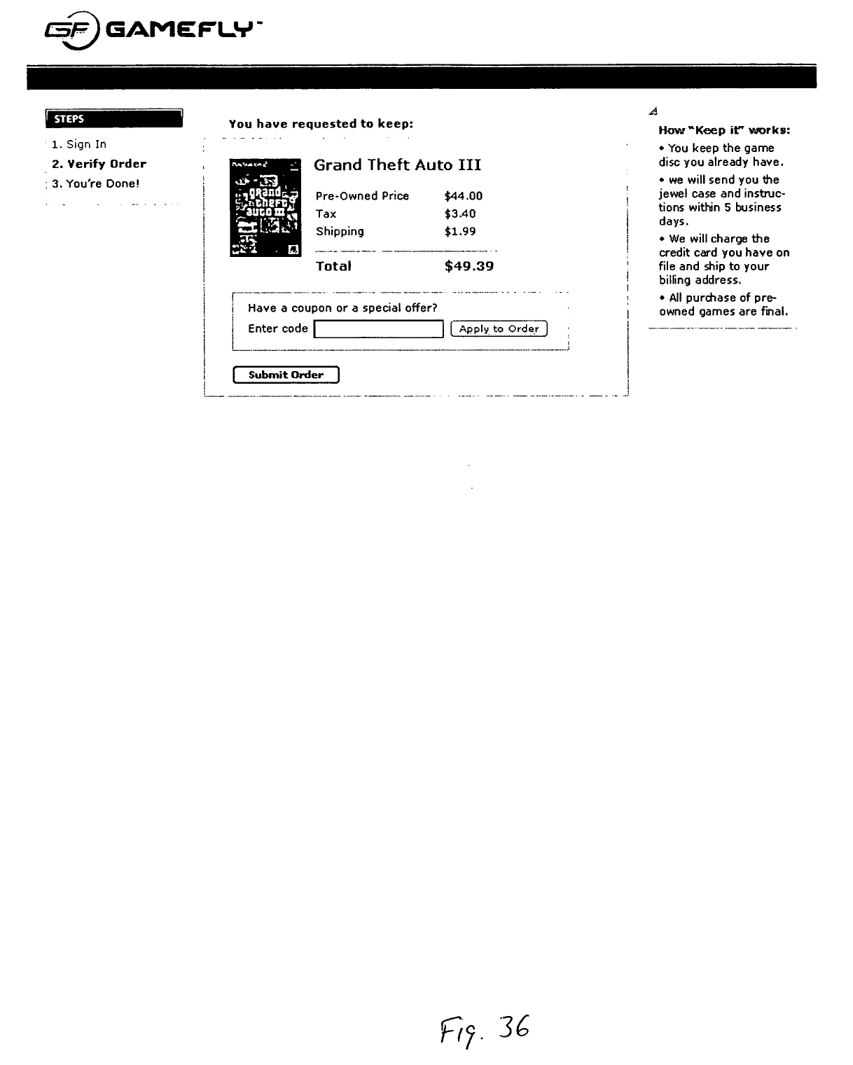

FIG. 37 is a web page exemplar according to the present invention.

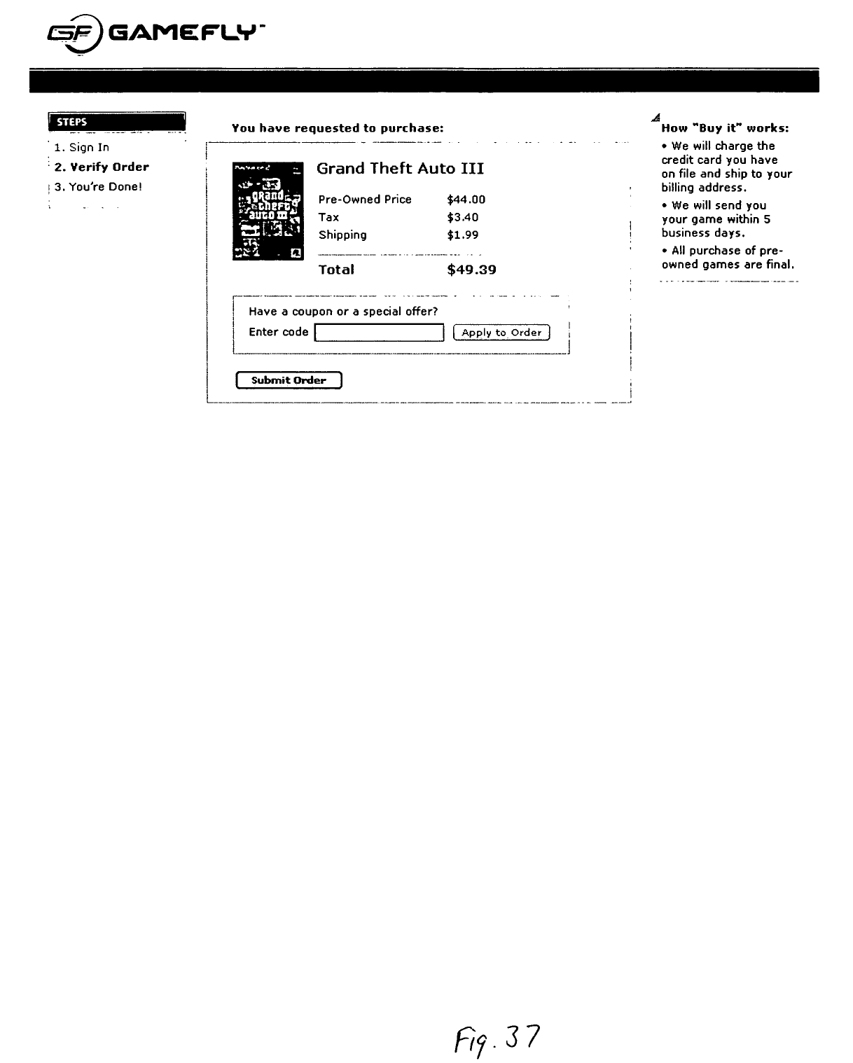

FIG. 38 is a web page exemplar according to the present invention.

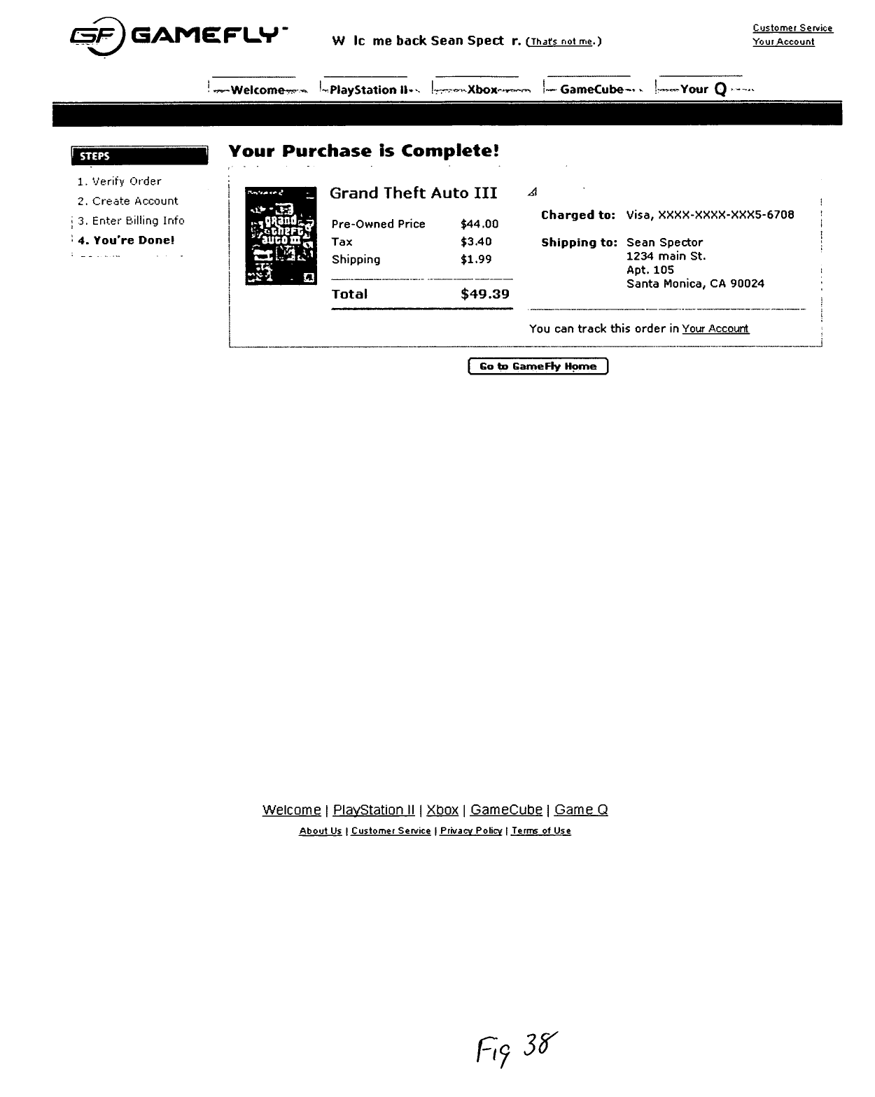

FIG. 39 is a web page exemplar according to the present invention.

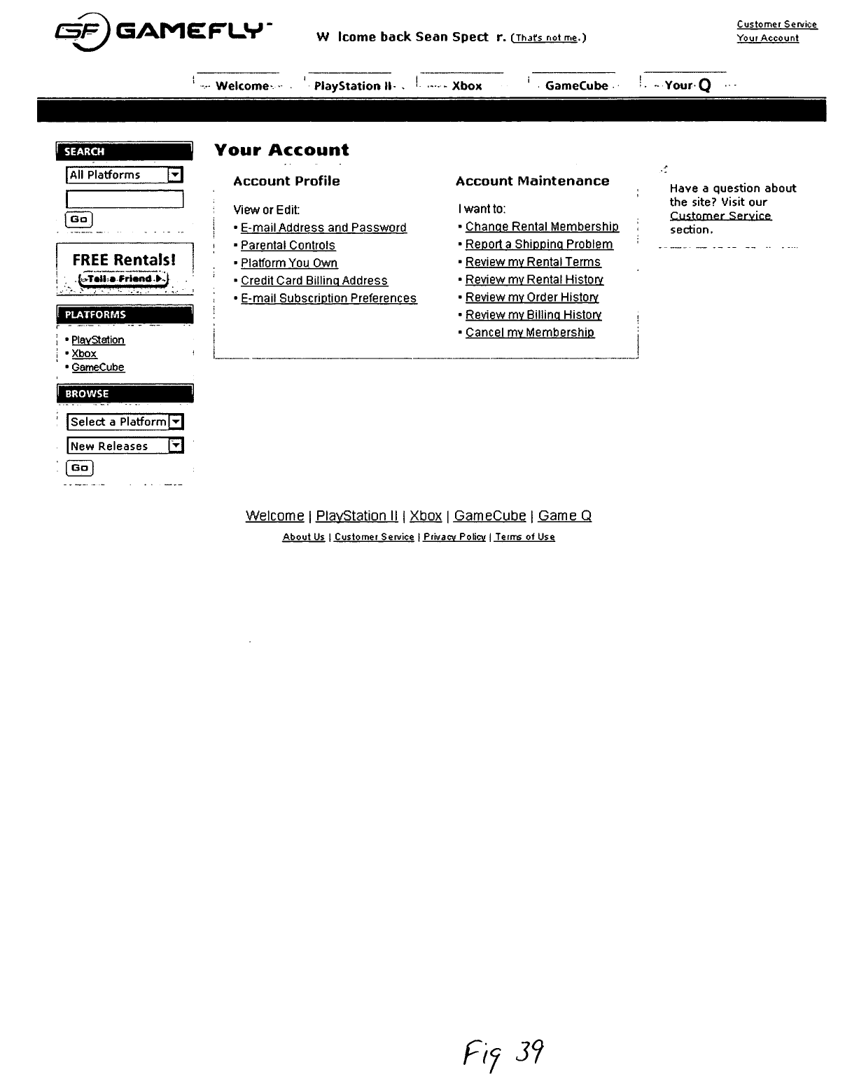

FIG. 40 is a web page exemplar according to the present invention.

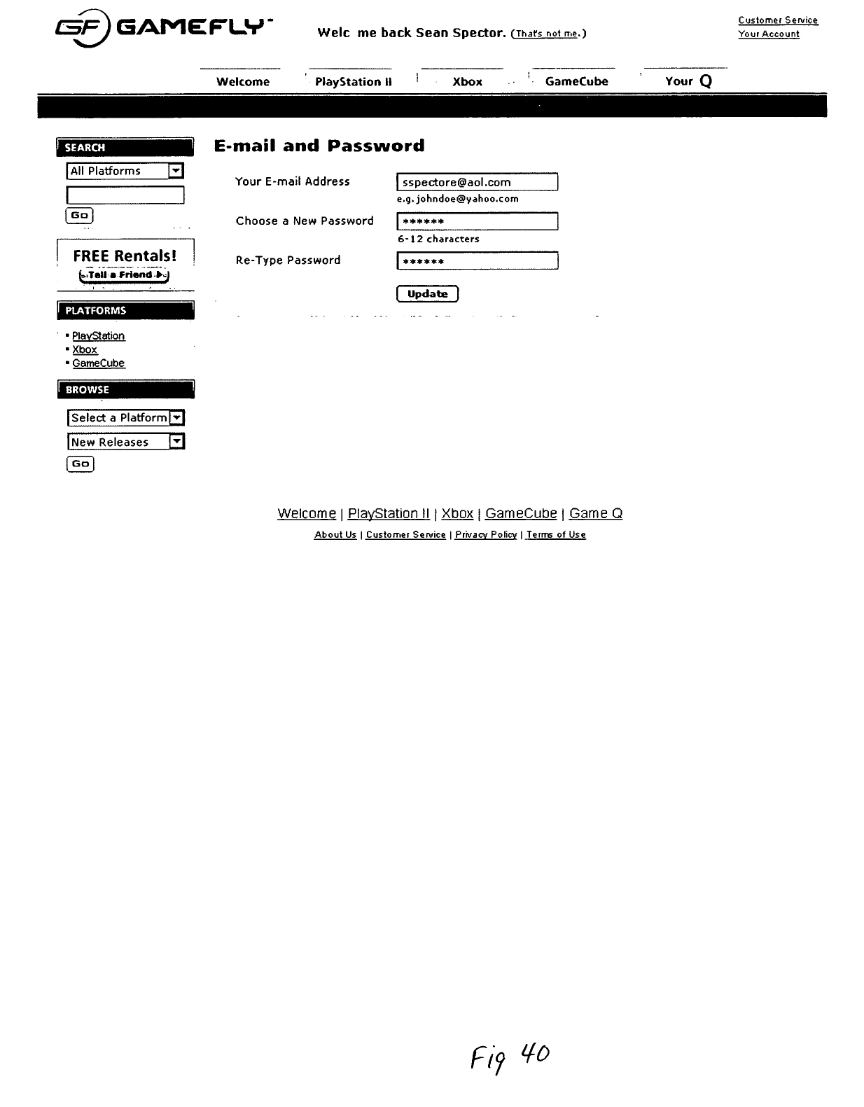

FIG. 41 is a web page exemplar according to the present invention.

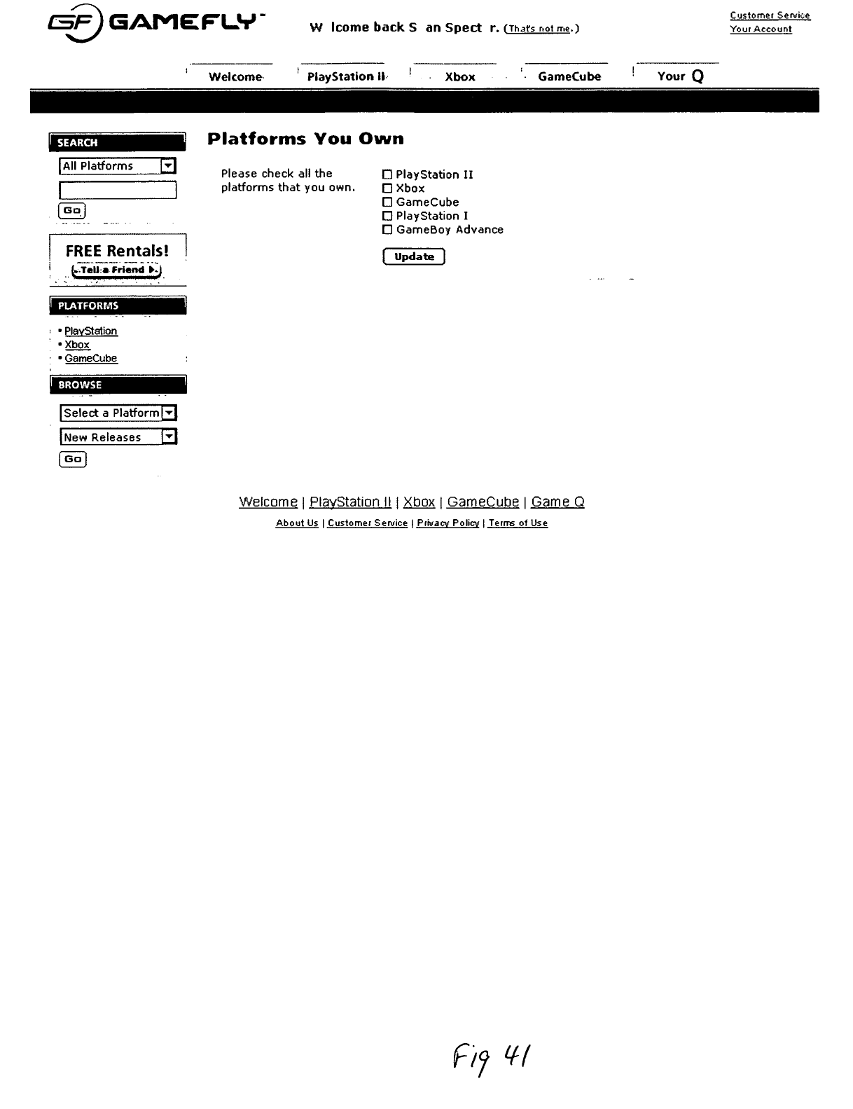

FIG. 42 is a web page exemplar according to the present invention.

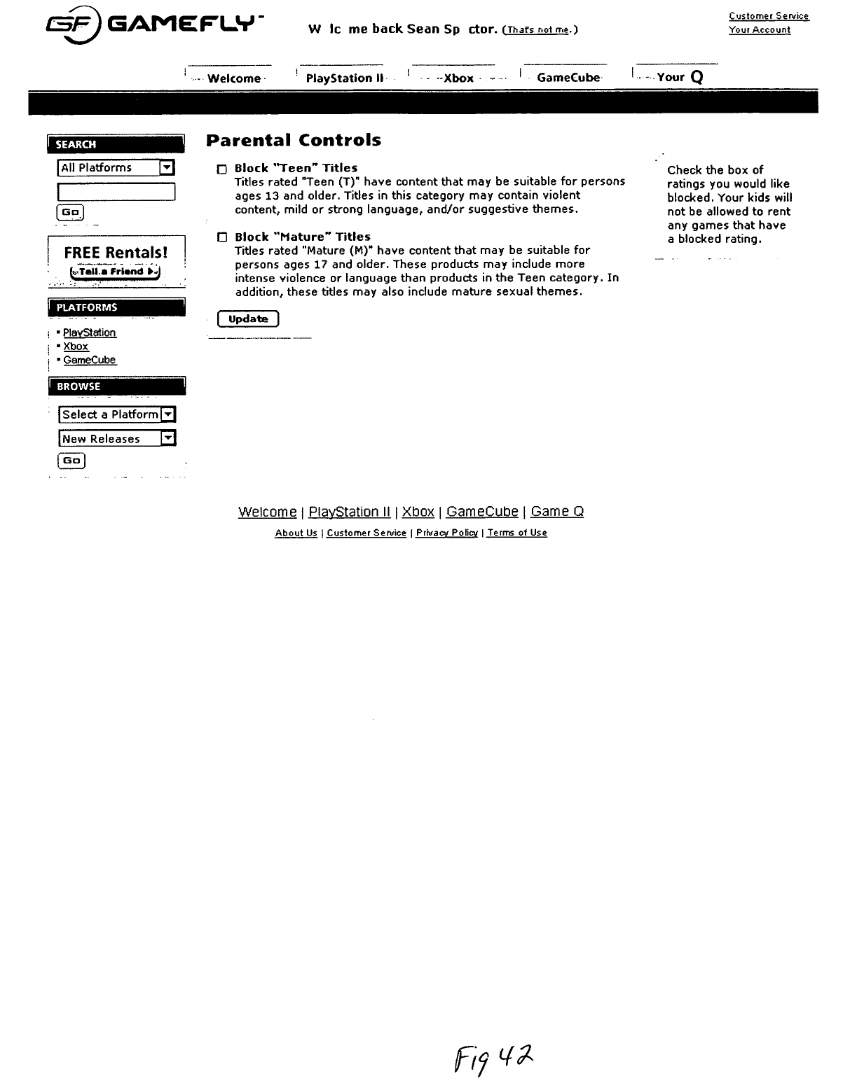

FIG. 43 is a web page exemplar according to the present invention.

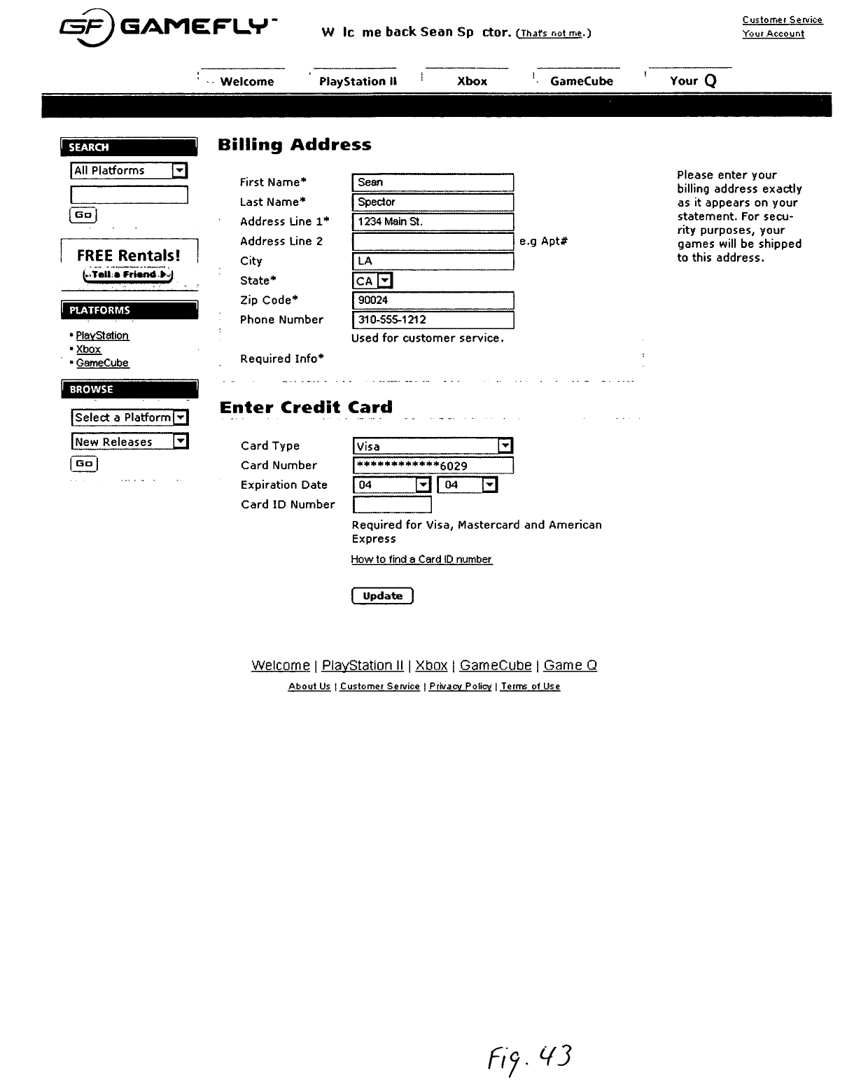

FIG. 44 is a web page exemplar according to the present invention.

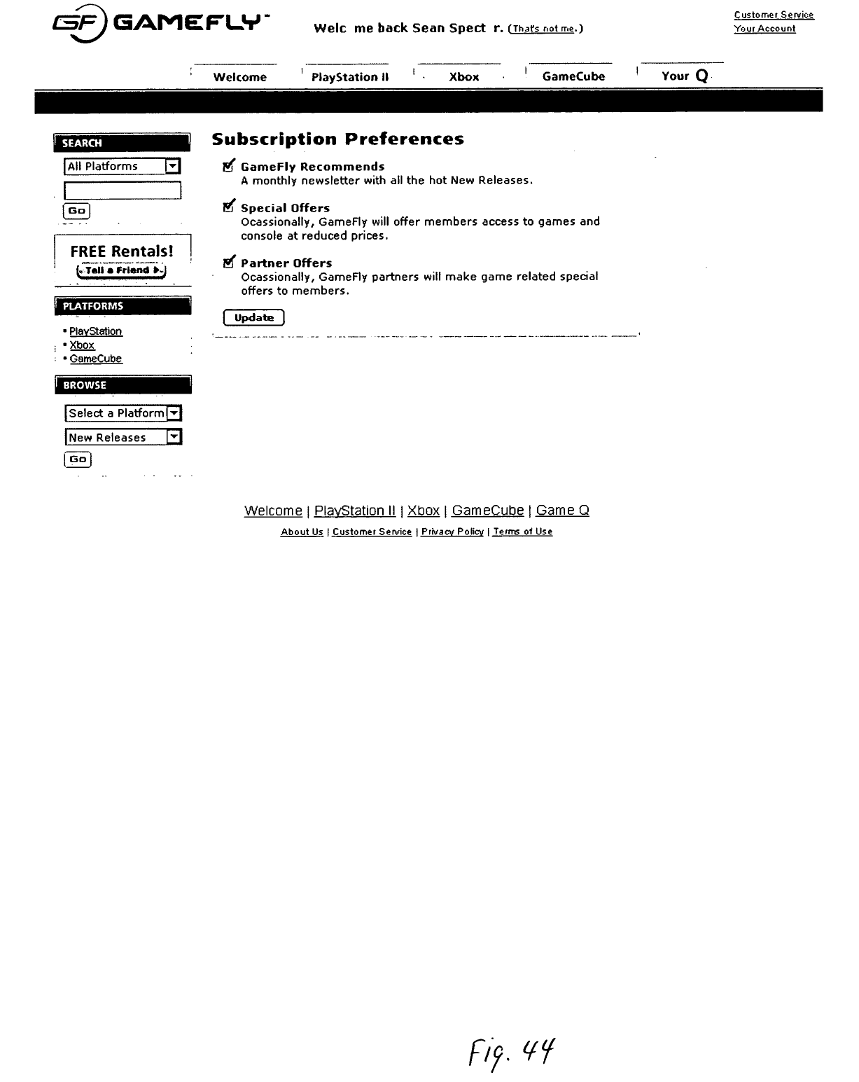

FIG. 45 is a web page exemplar according to the present invention.

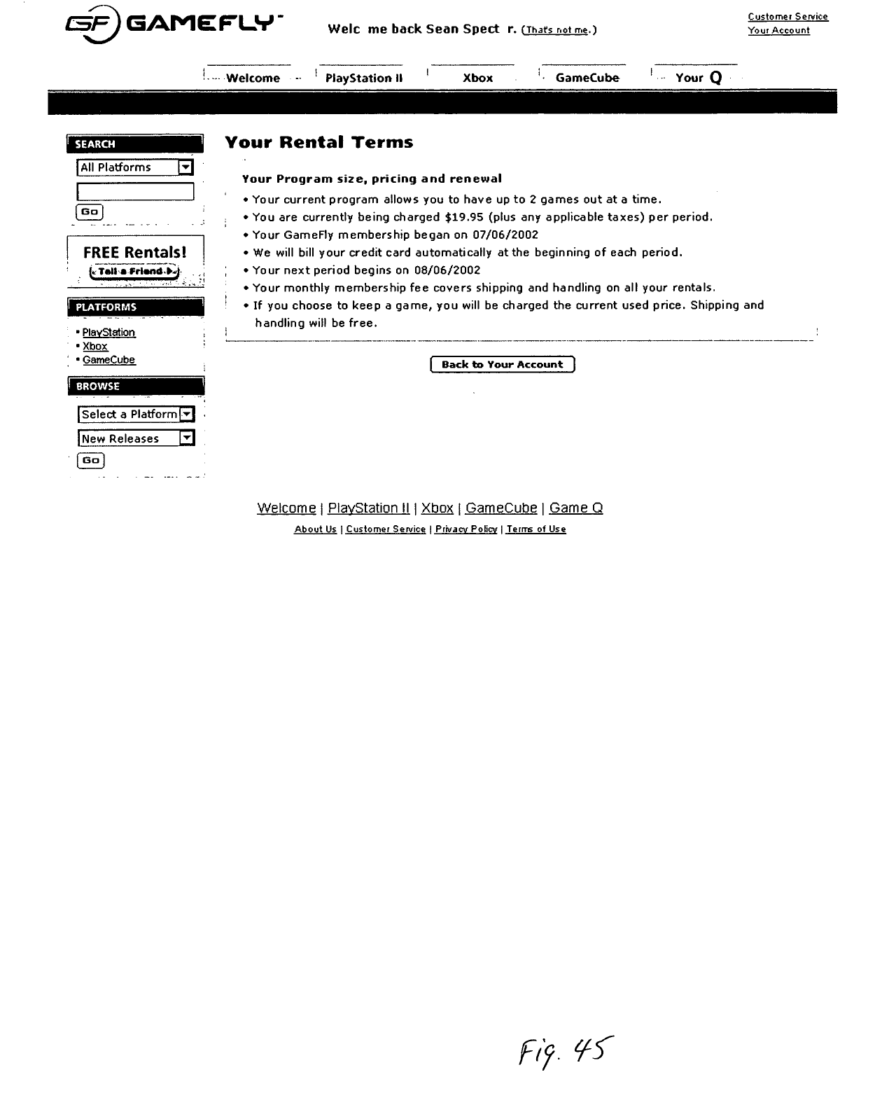

FIG. 46 is a web page exemplar according to the present invention.

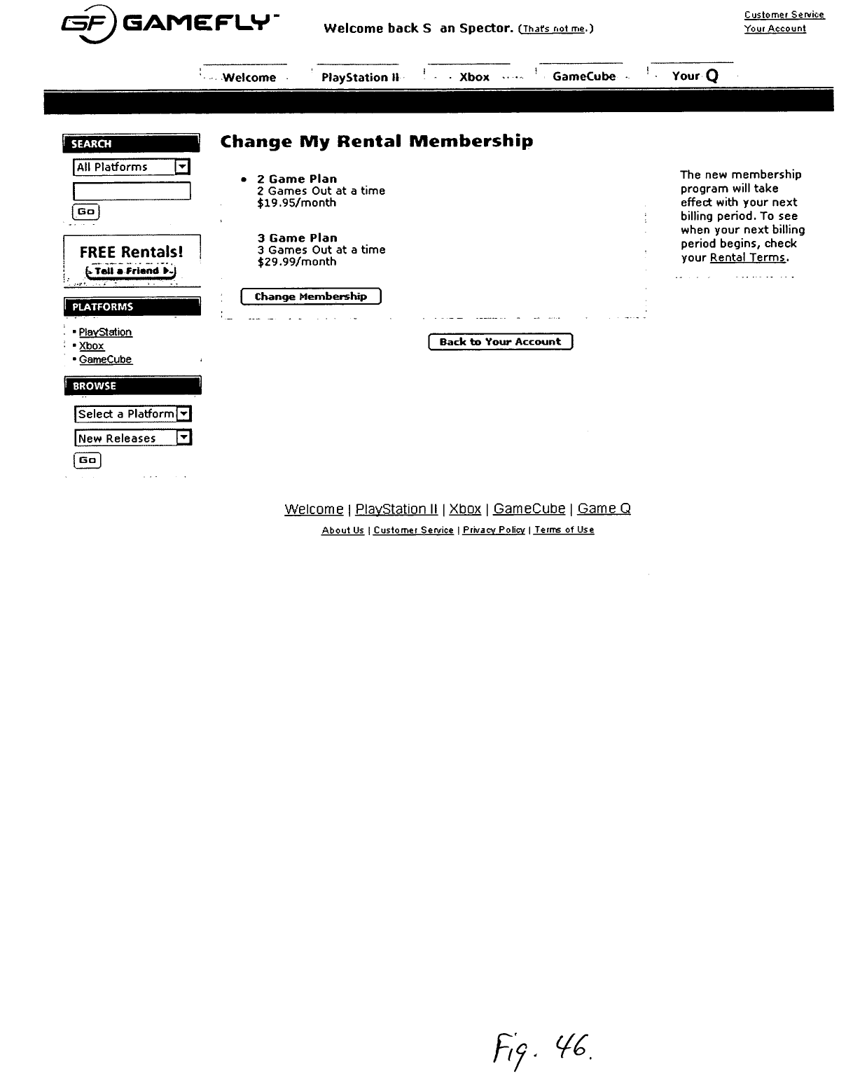

FIG. 47 is a web page exemplar according to the present invention.

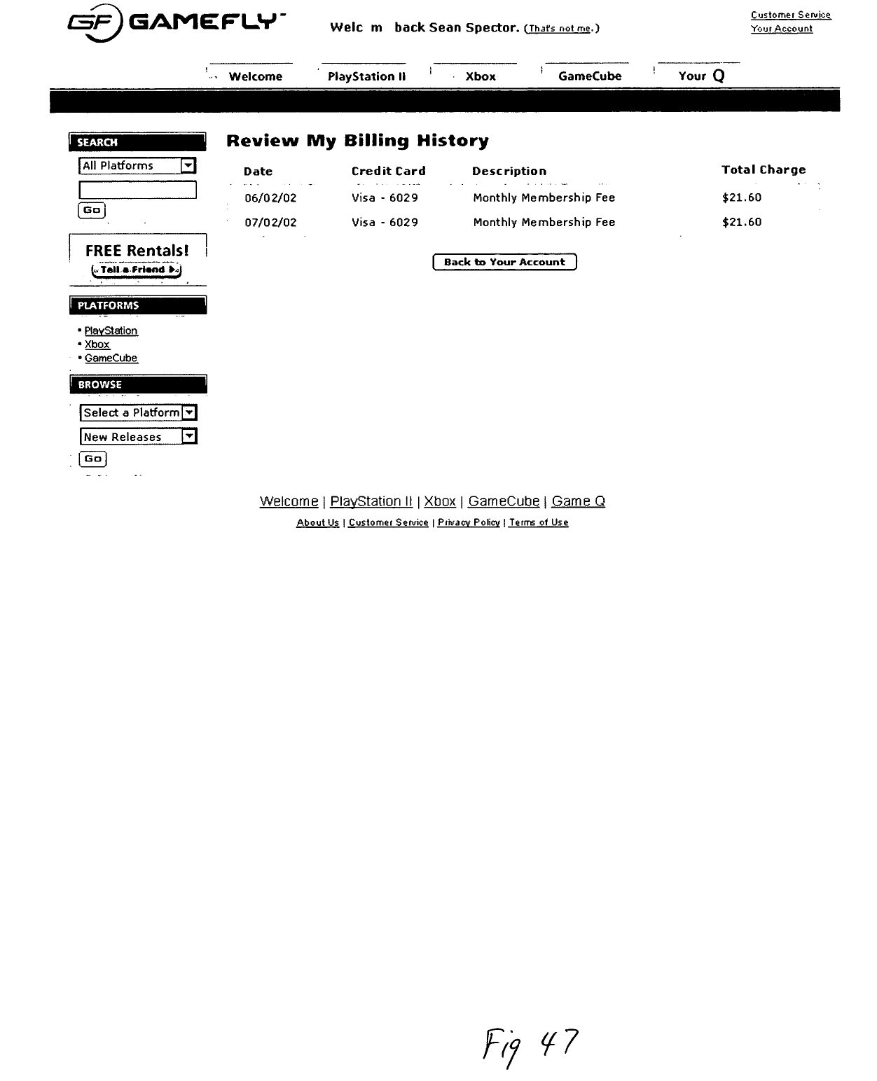

FIG. 48 is a web page exemplar according to the present invention.

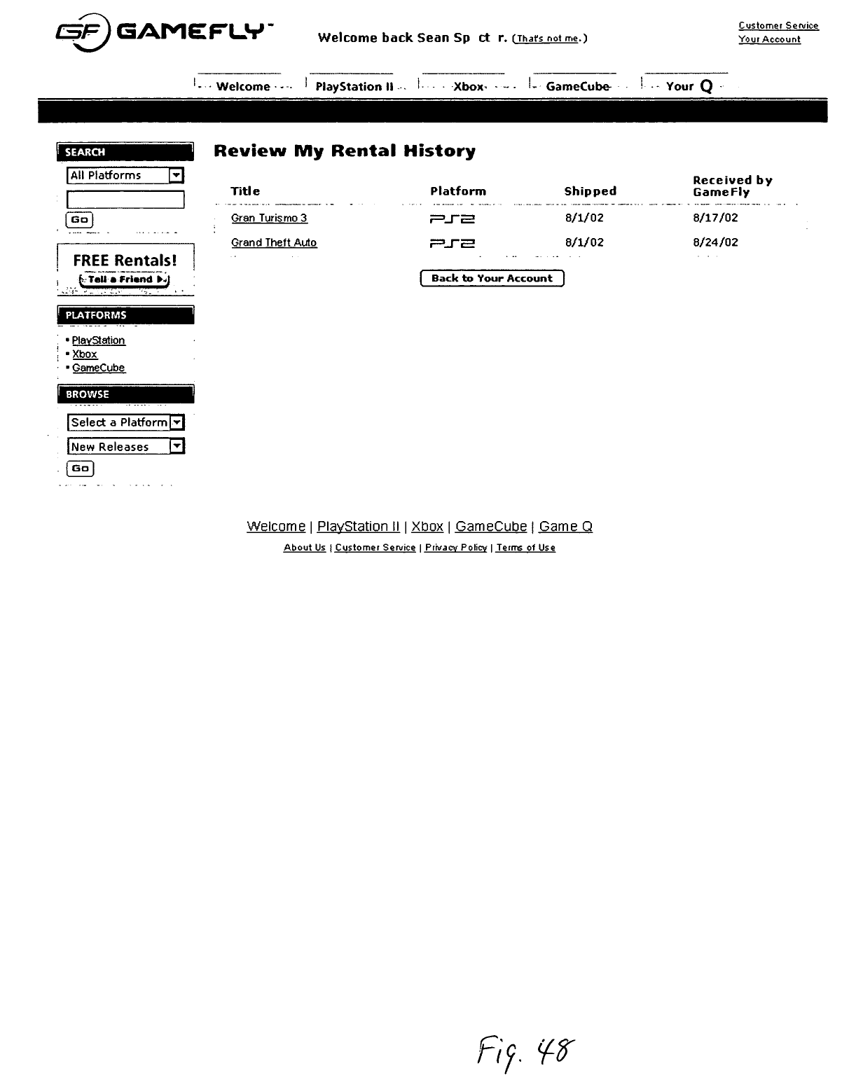

FIG. 49 is a web page exemplar according to the present invention.

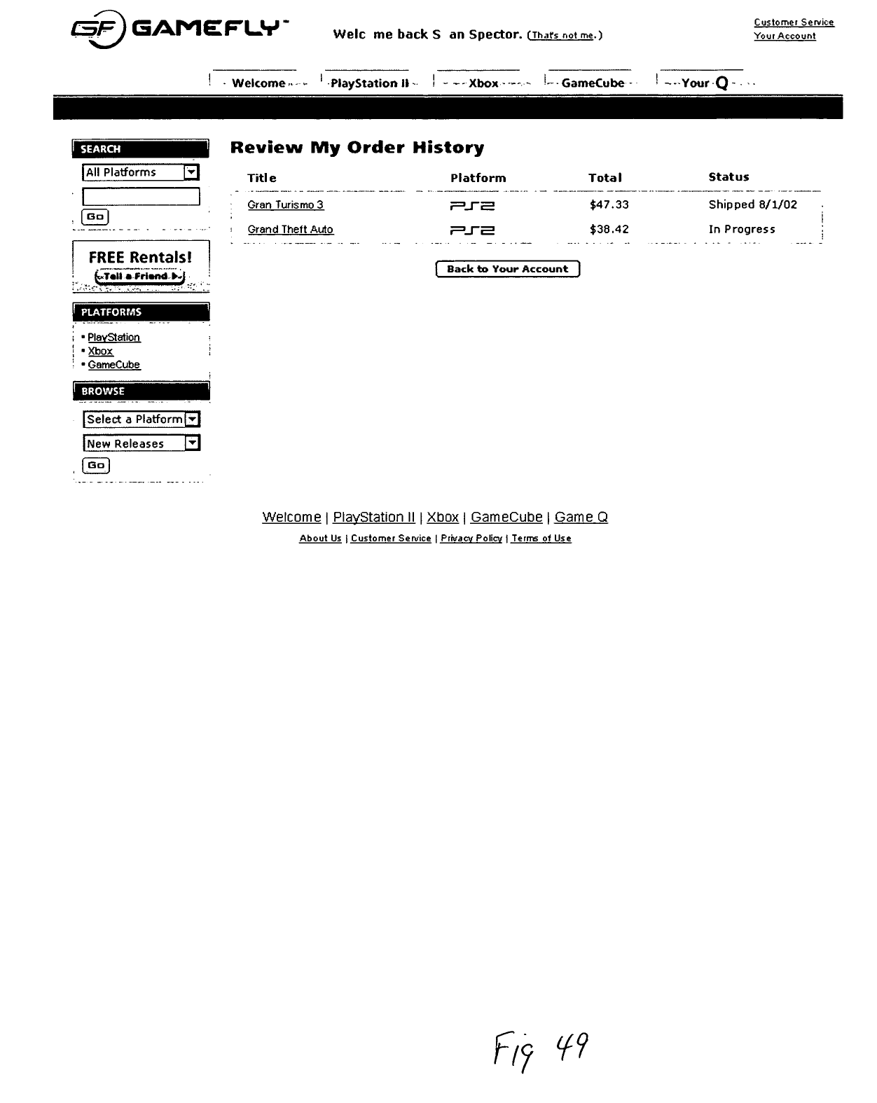

FIG. 50 is a web page exemplar according to the present invention.

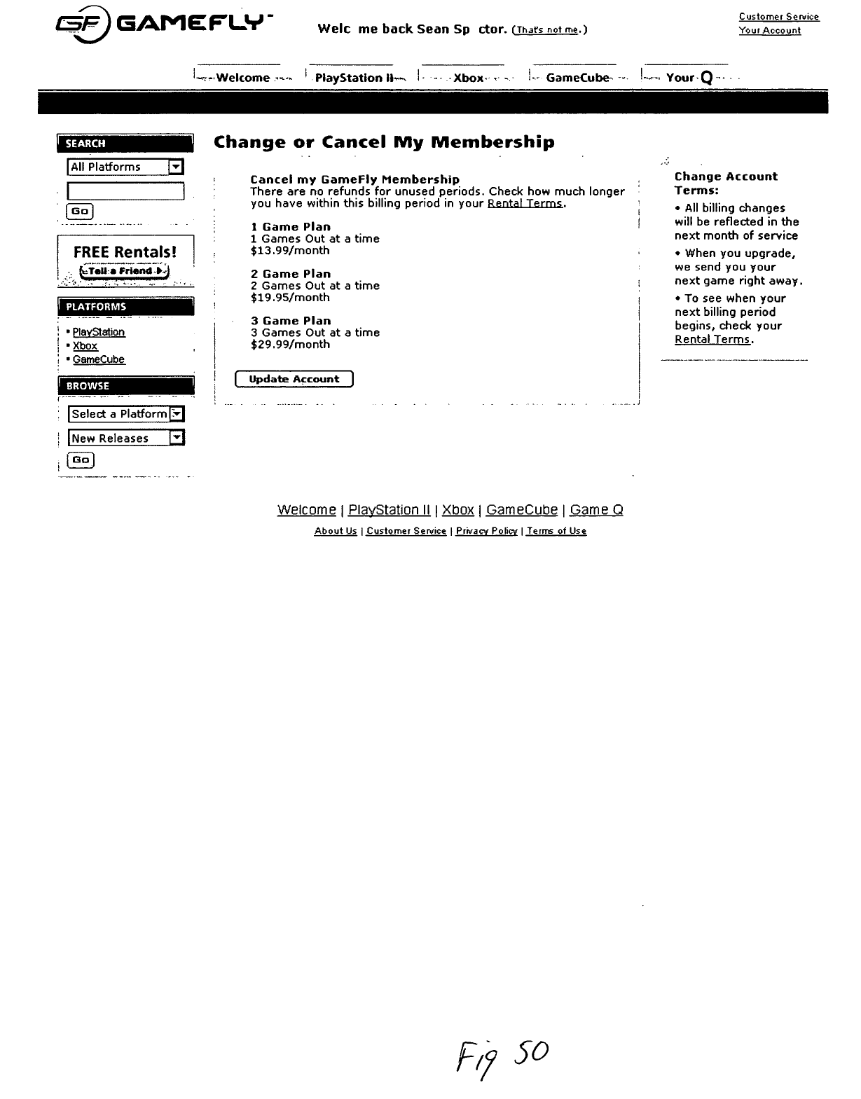

FIG. 51 is a web page exemplar according to the present invention.

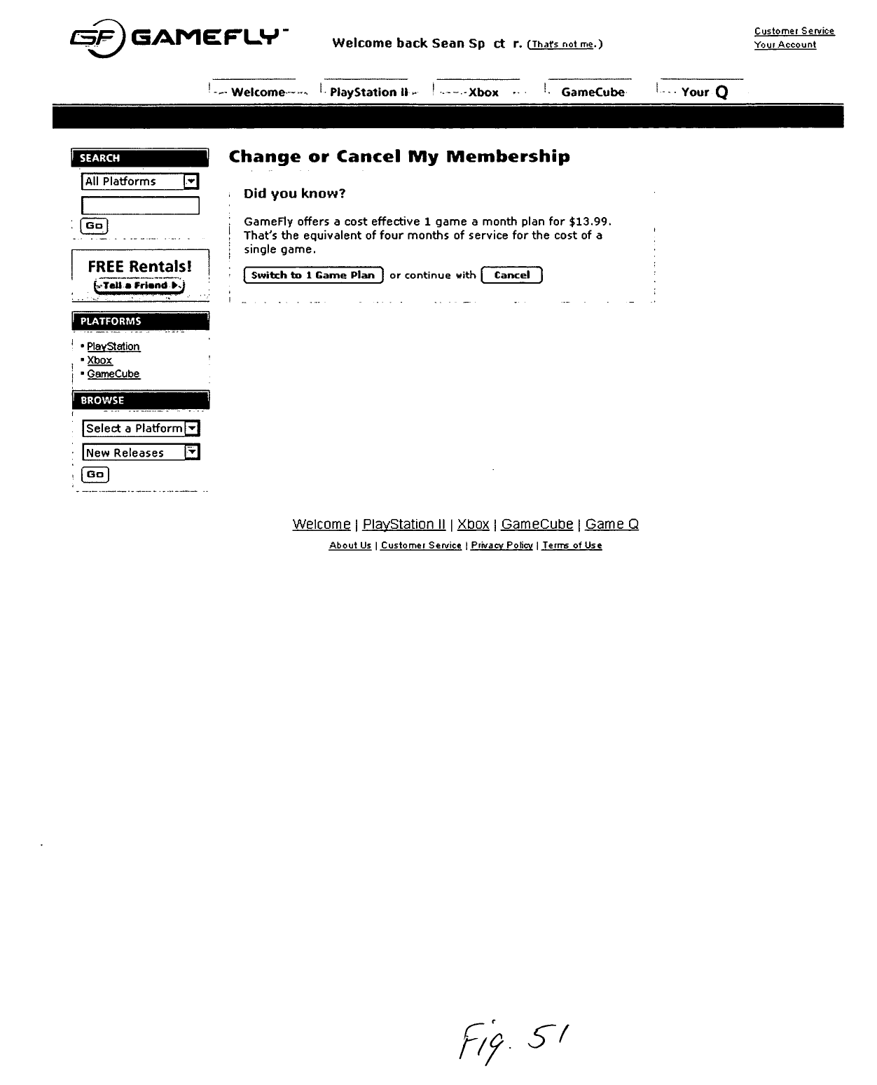

FIG. 52 is a web page exemplar according to the present invention.

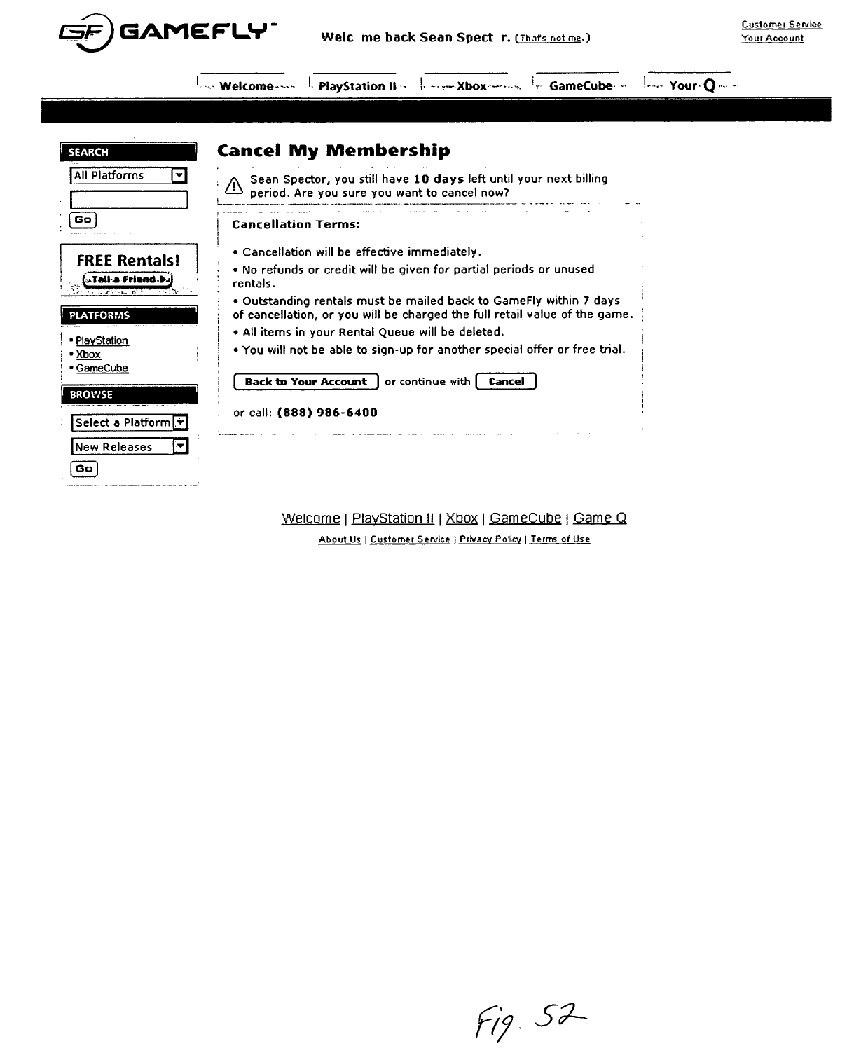

FIG. 53 is a web page exemplar according to the present invention.

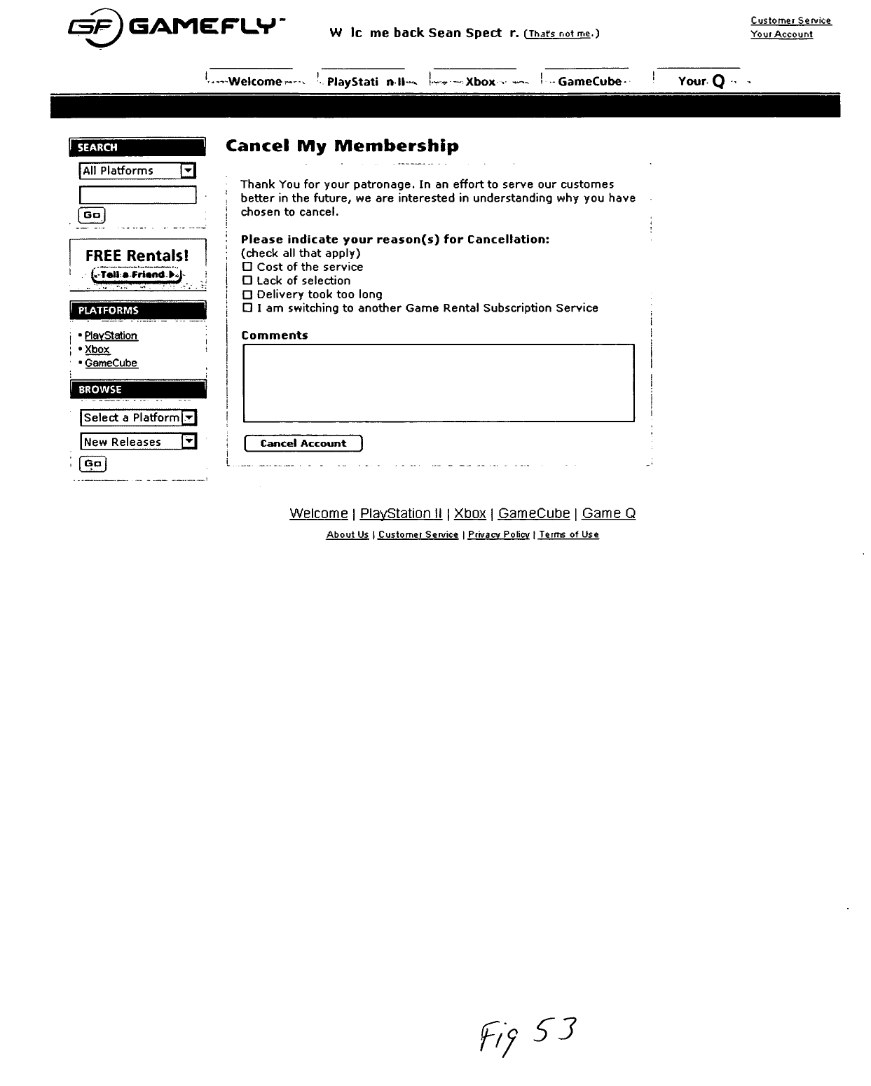

FIG. 54 is a web page exemplar according to the present invention.

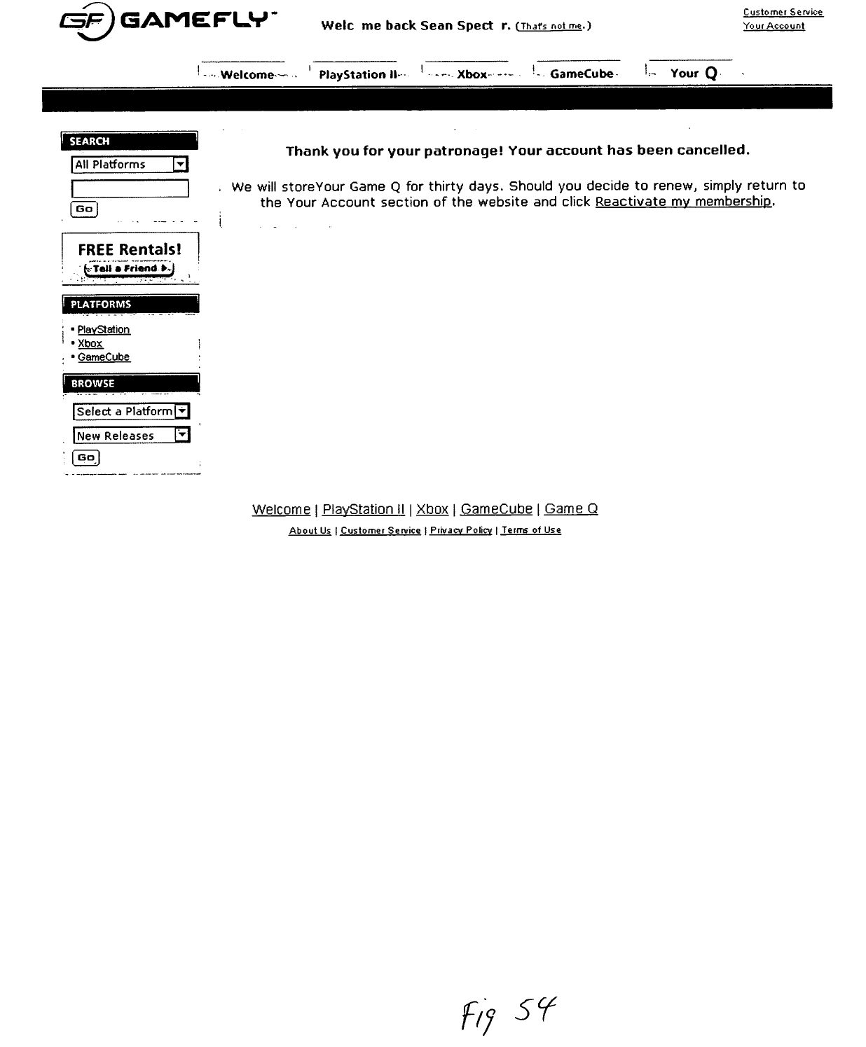

FIG. 55 is a web page exemplar according to the present invention.

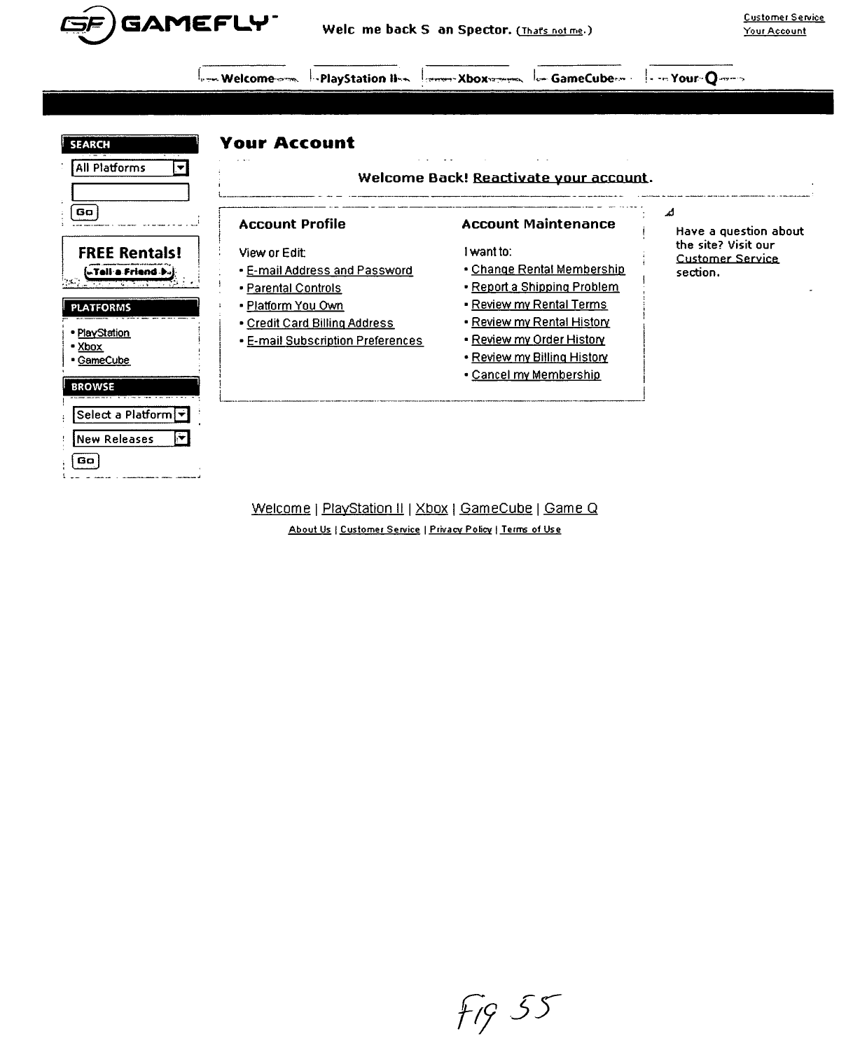

FIG. 56 is a web page exemplar according to the present invention.

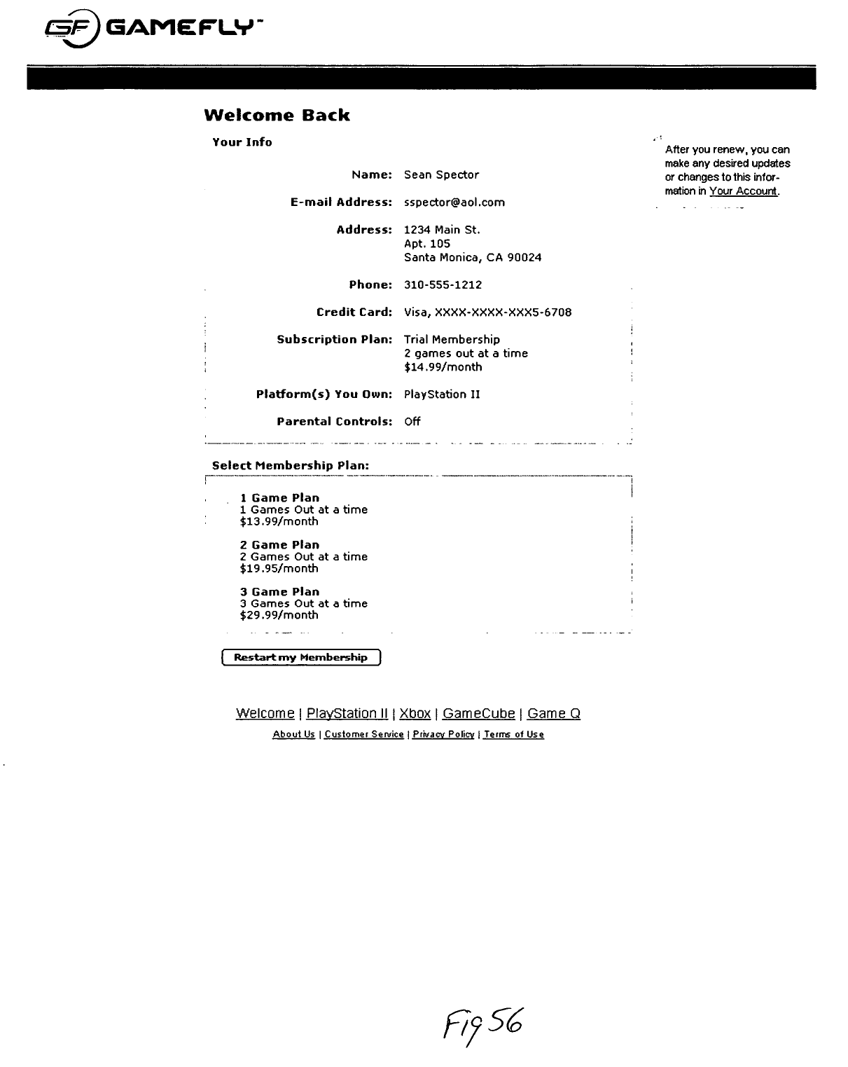

### DETAILED DESCRIPTIONS OF THE PREFERRED EMBODIMENT(S)

This invention may be applied to rental and sales of electronic entertainment items such as electronic games, video games, game cartridges and disks, game software, movies and music. For convenience, the present invention is described with respect to video games.

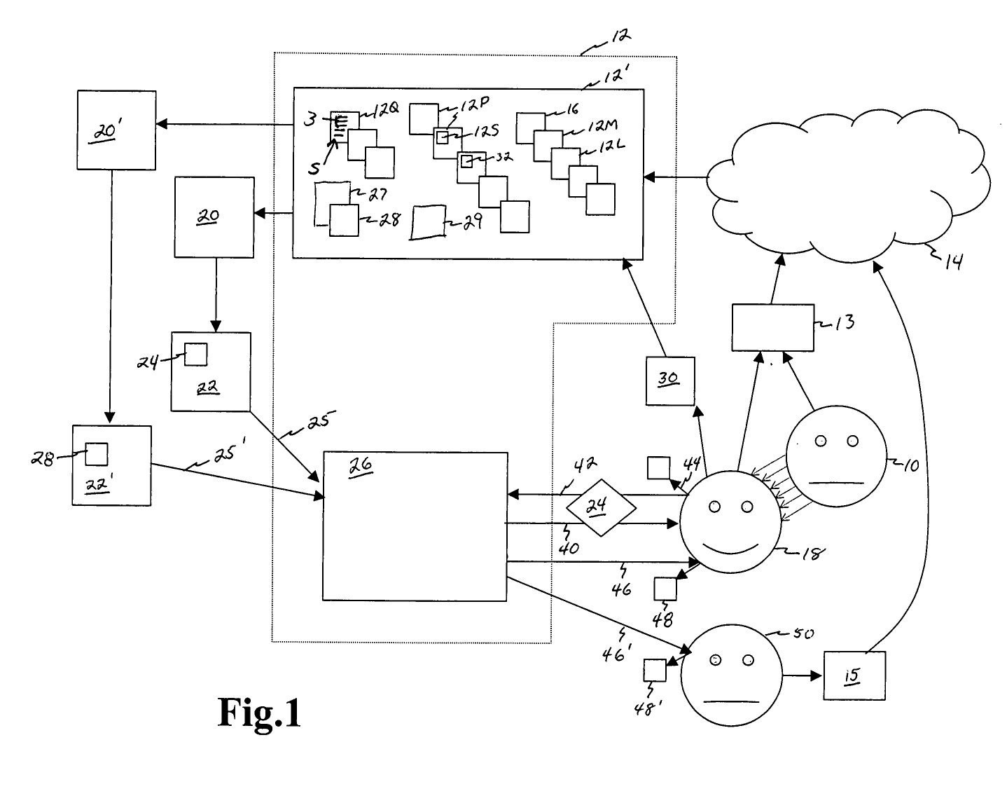

Referring now to FIG. 1, a potential video-game renter such as user 10 may access a rental service 12 using any suitable method such as telephone, a computer network such as the World Wide Web or the internet, or through a traditional retail outlet. In a currently preferred embodiment of the present invention user 10 may access a rental service port 12′ using any suitable access port such as computer 13 and a network such as network 14. Using network 14, rental service 12 may establish one or more web pages 12P. Rental service 12 may permit a user such as user 10 to register membership 12M. Upon registration, user 10 becomes member 18 and then may browse one or more listings 16 containing inventory available for sale or rent such as listing 12L containing video game inventory available for rent. Each member may also create at least one list such as list 12Q of video games that they wish to play, or other electronic entertainment items they wish to receive. List 12Q is a game rental Q, and may be referred to as the “Game Q”.

List 12Q is a priority listing of electronic entertainment items desired by member 18. List 12Q may contain a preselected number of slots S for entry of electronic entertainment items with a subset of the slots, top slots 3, used by rental service 12 to determine demand for electronic entertainment items. Top slots 3 may be any number of slots and in a currently preferred embodiment of the present disclosure top slots 3 may include the top four priority entries of each members list 12Q.

Based on analysis of list 12Q, and or top slots 3 for all members such as member 18, rental service 12 may be able to prepare appropriate purchase orders such as wholesale purchase orders 20 and 20′ for games or other electronic entertainment. The quantity of electronic entertainment items 22 or 22′ such as game 24 or game 28 respectively, that are purchased by rental service 12 may be determined by software 28 using the preferences expressed by members such as member 18 in their Game Qs. Electronic entertainment items 22 and 22′ may be received into a central inventory such as inventory 26, and constitute an inflow of electronic entertainment items to rental service 12.

Members such as member 18, in return for consideration 30 such as a monthly subscription fee, may receive at least one electronic entertainment item such as games 24 or 28 from their list 12Q in action 40. Members may have in their possession a pre-selected number of electronic entertainment items 22, typically, members are on a 2-game plan, which entitles them to have two rental games from list 12Q in their possession. Electronic entertainment items such as game 24 may be transferred via action 40 to member 18 by any suitable means, in a currently preferred embodiment of the present invention game 24 may be sent to member 18 via regular mail including a prepaid return envelope. When member 18 receives game 24, member 18 has the option, at any time while they have game 24 in their possession, of keeping game 24 as action 44, for a purchase price 32 set by rental service 12. Purchase price 32 may be referred to as the “keep it” price and may be visible on web page 12P. If member 18 does not keep game 24, member 18 simply returns game 24 as action 42 to rental service 12. In a currently preferred embodiment of the present invention member 18 may not directly pay shipping or postage costs related to electronic entertainment items rented or purchased. Shipping or postage costs may be included in consideration 30.

When member 18 returns as action 42 a rented game such as game 24, rental service 12 then sends out the next electronic entertainment item available from list 12Q of member 18. In this way, member 18 continuously has 2 electronic entertainment items 22 from rental service 12. When member 18 decides to “keep” a rented game using action 44, this constitutes an outflow of electronic entertainment items 22 from the inventory 26. When a member returns a rented game, this does not result in a change in inventory 26.

Rental service 12 may also list electronic entertainment items 22 available for purchase through any suitable means. In a currently preferred embodiment of the present invention electronic entertainment items 22 available for purchase appear on list such as list 12S on a web page such as web page 12P. A member may choose to purchase an electronic entertainment item using action 46, for the price listed at the web site, whether or not the electronic entertainment item is on list 12Q.

Non-members such as user 50, not part of the subscription rental service 12, may also browse online game listings such as list 12S and make purchases using action 46′. This activity is referred to as “buy it”. If a member 18 or a non-member such as user 50 “buys” a game listed at the web site using actions 46 and 46′ respectively, this results in an outflow of a game 48 or 48′ respectively from inventory 26.

All electronic entertainment item sold through members and non-members are pre-owned games that have already been unsealed from their original packaging and in most cases, already rented and used by members. As such, the prices charged for electronic entertainment items are almost always expected to be below the retail price that new, unsealed electronic entertainment items sell for at mass-market retailing stores.

Inventory 26 may be increased by wholesale purchases such as purchases 25 and 25′. There is no change to inventory 26 when a member 18 rents and returns a game using actions 40 and 42 respectively. The service's central inventory decreases when member 18 decides to keep a rented game in their possession using action 44, or when a member or nonmember purchases a game listed by rental service 12 using actions 46 and 46′ respectively.

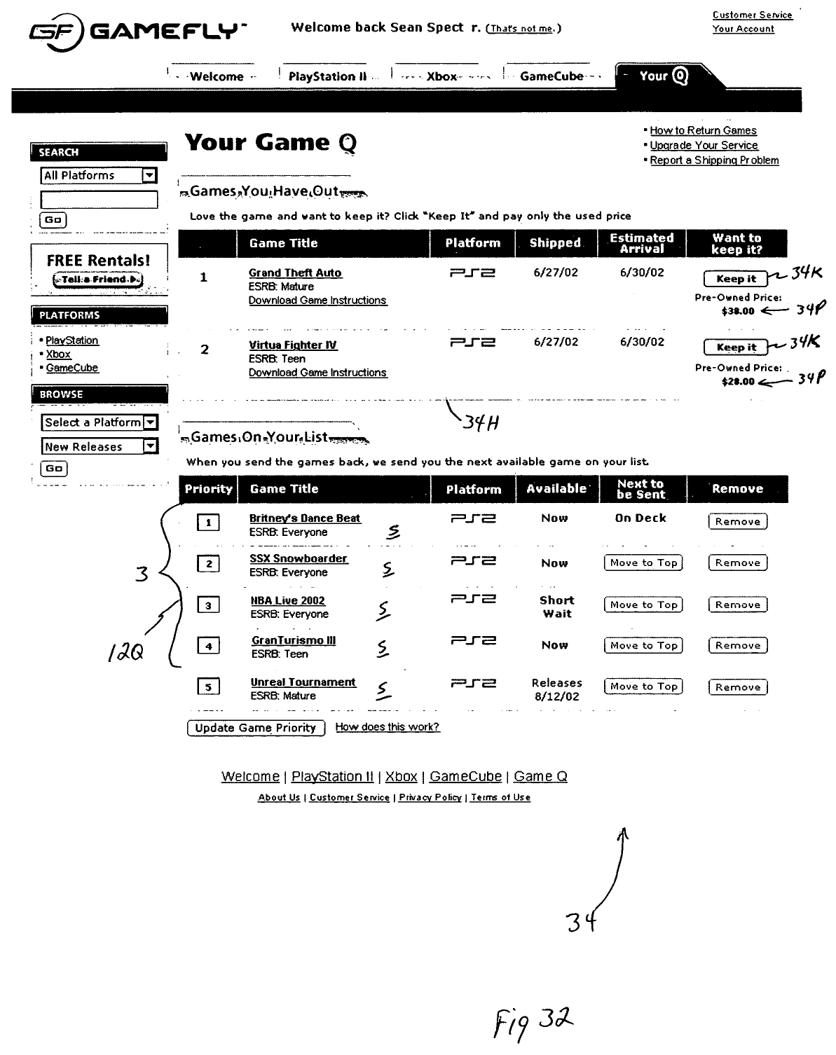

At the service's web site, members who have games rented will see buttons next to those games that say “keep it”, and will see the corresponding price they must pay, referred to as the “keep-it price.” They typically will see these keep-it buttons and prices on the web page listing their Game Q (see, e.g., FIG. 32), but they may also see these on other web pages. Since they are not rental subscribers, non-members will not see keep-it buttons and keep-it prices.

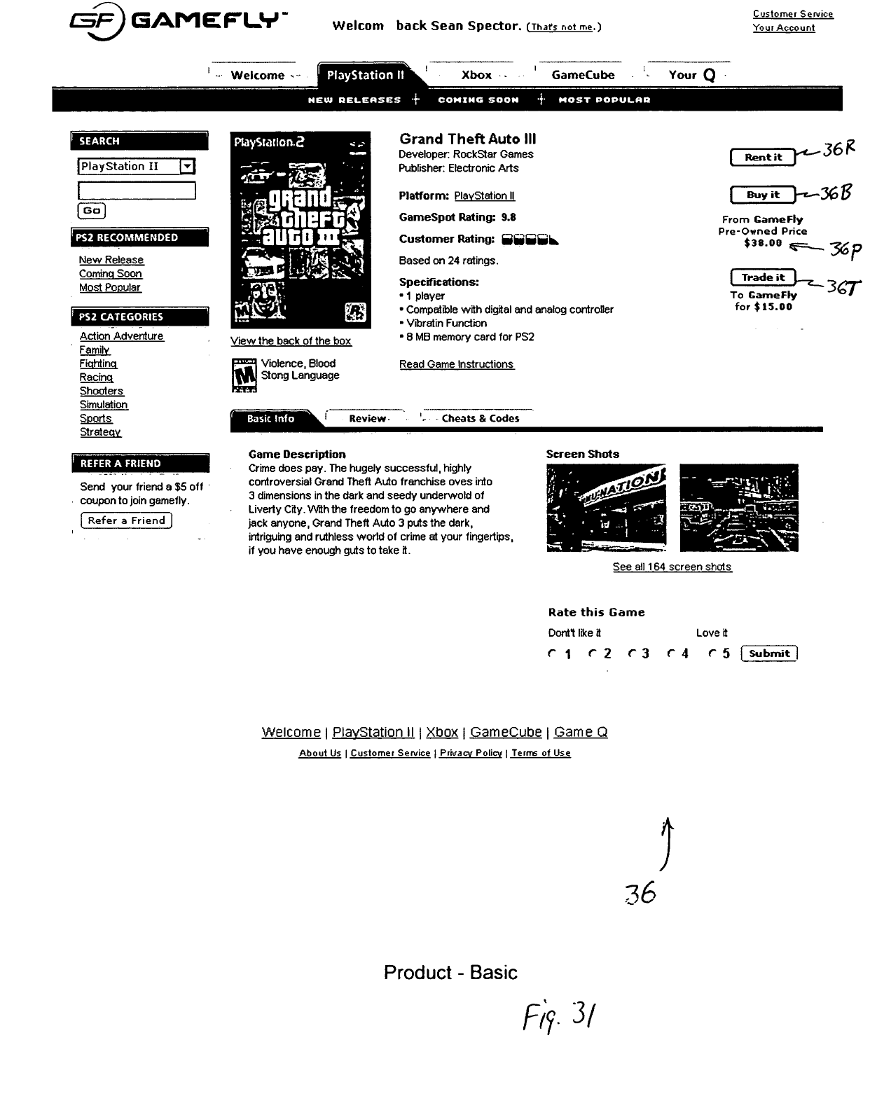

Both members and non-members visiting the web site will see game product description pages. These pages will have buttons for “rent it” and “buy it” and a corresponding “buy-it” price (See, e.g., FIG. 31). If a member clicks on “rent it”, the game is added to their Game Q (See FIG. 32). If a non-member clicks on “rent-it,” they are prompted to become a rental subscriber. Both members and non-members can click on “buy it” and purchase any game listed at the web site for the corresponding “buy-it” price. The game is then mailed to the purchaser.

Referring now to FIG. 31, page 36 is a mockup of a game product description page, with rent-it button 36R, buy-it button 36B, and corresponding buy-it price 36P. Trade it button 36T may also be available.

Referring now to FIG. 32, page 34 is a mockup of a Game Q page that a member would see. Page 34 may include list 12Q showing a preselected number of slots S and at least top slots 3. List 34H includes electronic entertainment items currently in possession of member 18, and may also include keep-it buttons 34K and keep-it prices 34P.

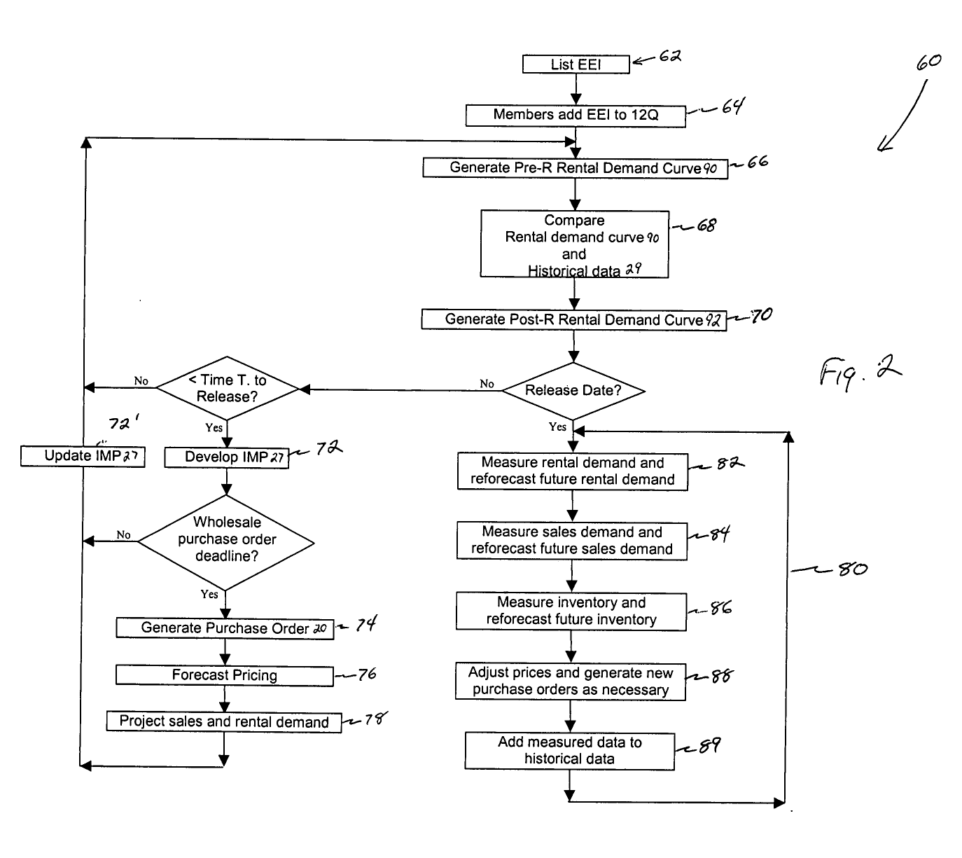

Referring now to FIG. 2, process 60 manages inventory 26 to provide electronic entertainment items to members such as member 18 and nonmembers such as user 50.

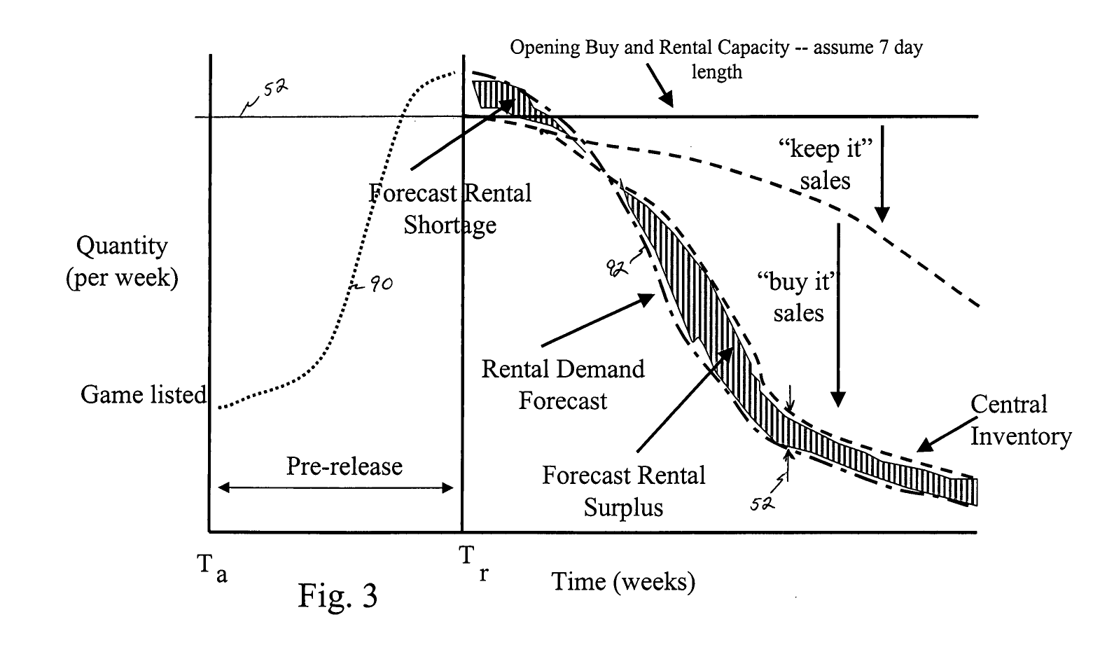

At step 62, a new electronic entertainment item such as game 24 is listed by rental service 12 prior to the release of game 24 to the general public. The time of the listing is denoted by Ta and is shown in FIG. 3. At time Ta, no wholesale purchase orders such as wholesale purchase order 20 have been placed for game 24 by rental service 12. The time between Ta and the time a game is released to the market, denoted by Tr, may vary but is generally 1 to 3 months.

Referring again to FIG. 2, at step 64 members may add game 24 to their list 12Q during the time period between Ta and Tr. The earlier they do so, and the higher they place the game on their list 12Q, the higher the member's priority to receive the first available rental shipments when the game is released. This encourages members too add games to their Game Q prior to a game's release.

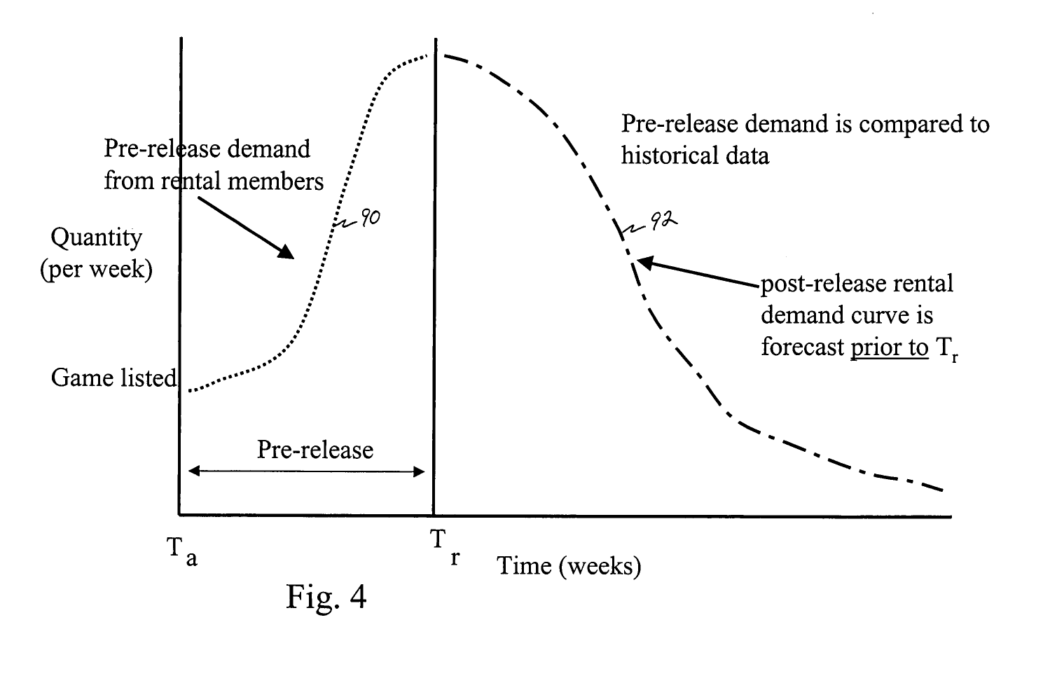

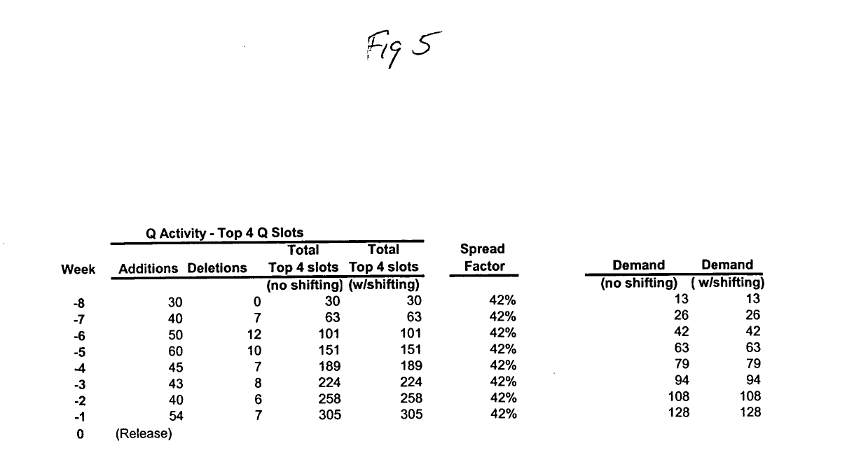

As members add the game to their list 12Q, the level of pre-release rental demand is measured on a continual basis. At step 66, pre-release rental demand curve 90 as shown in FIG. 4 may be generated. An example of pre-release data is shown in FIG. 5.

At step 68, pre-release rental demand curve 90 may be compared with historical data 29 from past games. Past games with similar characteristics and similar pre-release rental demand curves are selected as comparables. These comparables are analyzed to see how their post-release rental demand evolved, as well as post-release keep-it and buy-it sales. An example would be “Madden 2003”, a football themed game. Madden 2003 may be compared to prior Madden releases e.g. “Madden 2002” and other football and sports games among past releases.

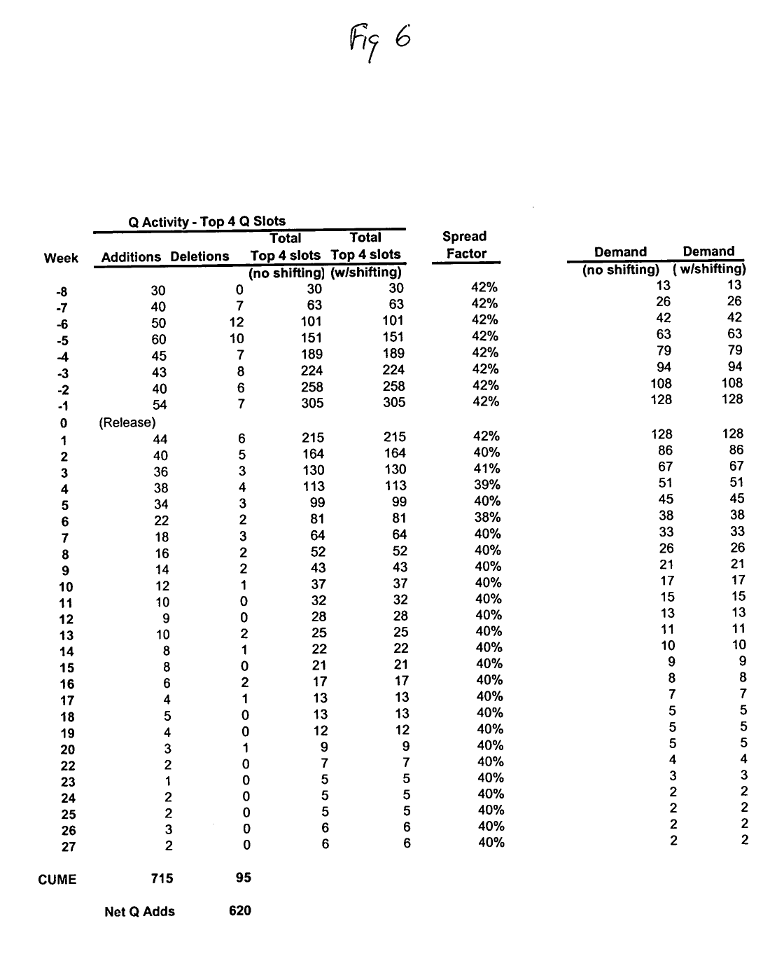

At step 70, post-release rental demand curve 92 may be forecast for game 24. Post-release rental demand curve 92 estimates the number of rental units that members will demand at a game's release date, and through time thereafter. As release date Tr approaches and pre-release rental demand 90 updates, post-release rental demand curve 92 may be continually updated. An example of post-release data is shown in FIG. 6.

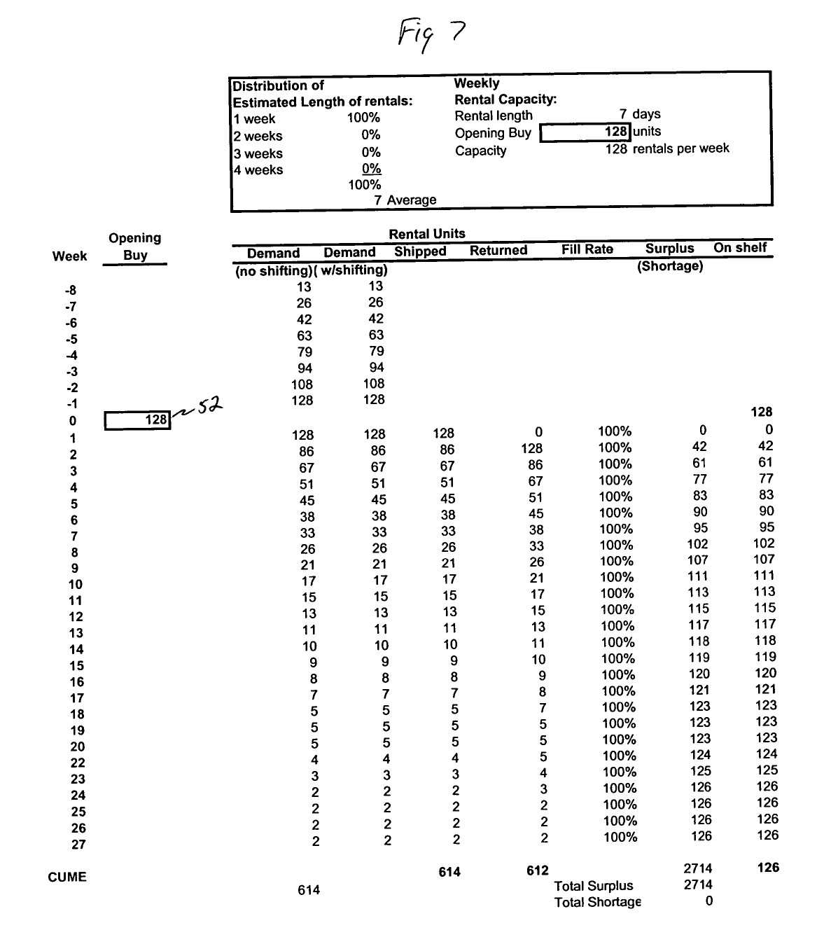

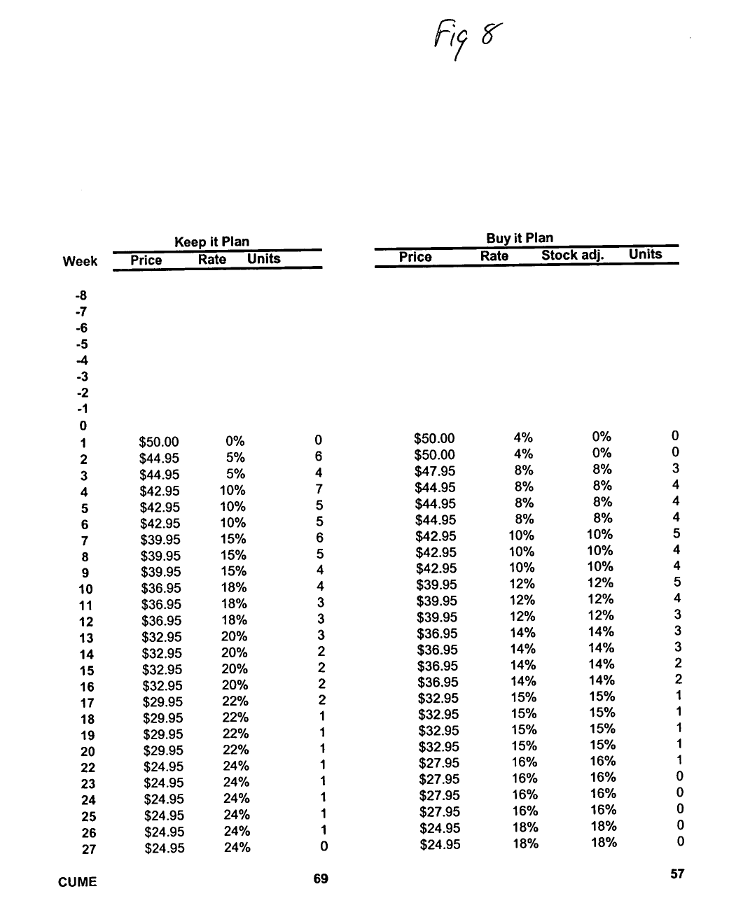

At step 72, detailed inventory management plan 27 (IMP) may be developed for game 24 see also FIG. 7 and FIG. 8. IMP 27 sets the initial purchase order quantity 52, or “opening buy,” and projects a plan for keep-it prices and quantities, and buy-it prices and quantities, over time. IMP 27 balances these plan variables to minimize the projected rental shortage in the early period after a release, and minimize the projected rental surplus in later time periods. The IMP is generally first developed 1-2 months prior to a game's release date, and is regularly regenerated at step 72′ as new data is collected.

As release date Tr approaches, generally within 1 month, at step 74, IMP 27 generates an “opening buy” purchase order such as wholesale purchase order 20 using post-release rental demand curve 92 and historical data 29.

At step 76 IMP generates a plan for keep-it and buy-it prices, over time (P_ki, P_bi_m, P_bi_nm, for all time periods). The plan generally reduces these prices over time, as demand for a game subsides. See FIG. 8.

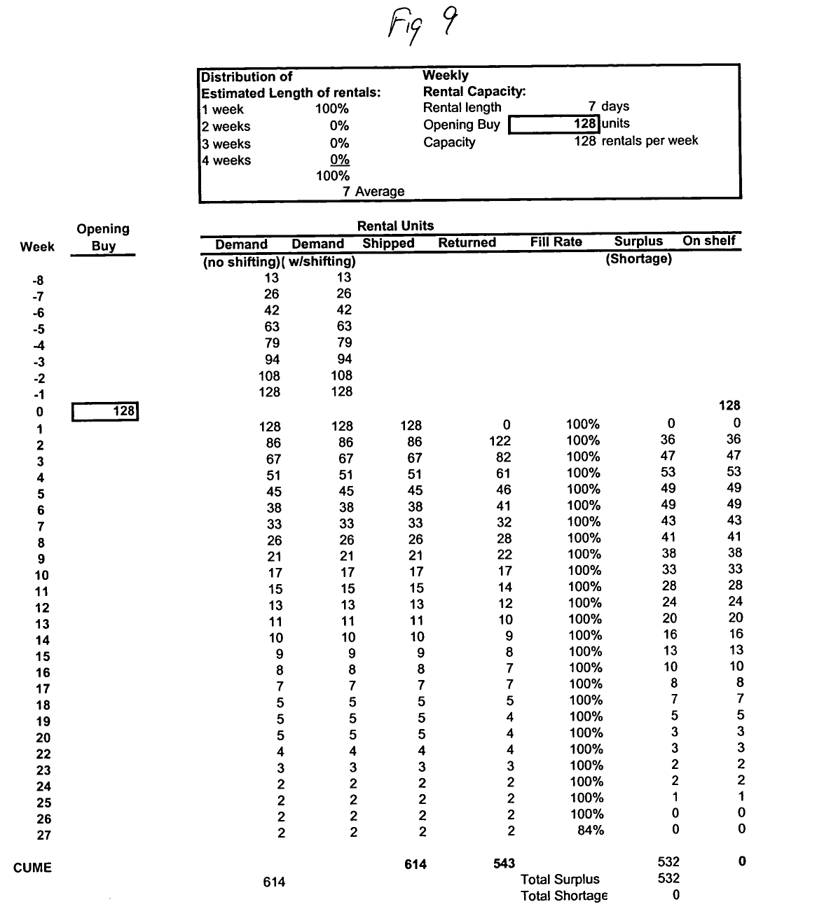

At step 78, based on forecast post-release rental demand, the opening buy, and the pricing plan for keep-it and buy-it, corresponding quantities of keep-it and buy-it unit sales are generated (Q_ki, Q_bi_m, Q_bi_nm, for all time periods). Cumulative unit sales increase over time, in order to reduce inventory 26 as demand for a game subsides, and to minimize the resulting rental surplus 52. See FIG. 9 for an example of projected demand and inventory.

Rental shortages and rental surpluses are also forecast as part of step 78. The primary objective of IMP 27 is to minimize both rental shortage 54 and the rental surplus 52. In addition, the IMP estimates profit opportunities from potentially strong demand for keep-it and buy-it at prices above wholesale purchase cost. If such opportunity is forecast, the IMP may call for an opening buy larger than rental demand, creating a rental surplus immediately upon a game's release. Conversely, the IMP may forecast extremely weak demand for keep-it and buy-it, and may generate a relatively low opening buy, resulting in relatively higher rental shortages immediately upon a game's release.

After a game is released at time Tr, parameters such as rental and purchase demand are tracked (“actuals”) and compared to IMP forecast parameters (“forecasts”) on a continual basis. Actuals can vary quite significantly from forecasts, and these variances are continually measured. As variances develop, IMP 27 may be regenerated as shown in loop 80 of FIG. 2.

At step 82, actual rental demand is measured, and future rental demand is re-forecast.

At step 84, actual keep-it and buy-it demand is measured, and future keep-it and buy-it demand is re-forecast, using existing IMP planned pricing trajectories.

At step 86, the central inventory, rental shortage and/or rental surplus are measured and re-forecast.

At step 88, keep-it and buy-it prices are adjusted, and new purchase orders can be generated.

Prices may adjust upward if inventory is too small relative to actual and projected rental demand, keep-it demand and buy-it demand. In addition, new purchase orders may be placed if projected shortages are large enough, and/or if the IMP projects, based on strong demand, incremental profit opportunities from additional purchases.

Prices adjust downward if central inventory is too large relative to actual and projected rental demand (rental surplus), keep-it demand and buy-it demand.

The magnitude of price adjustments is guided by the magnitude of the variances, the time period in the game's life cycle and comparisons from the historical database. The IMP can also be adjusted based on exogenous data, such as national sales and pricing data collected from 3rd party sources.

At step 89, the games actual IMP parameters (“actuals”) are added to historical database 29, and add to the statistical foundation for analyzing and developing IMPs for future releases of new games. Specifically, historical database 29, as it accrues data from new game releases, is refined to provide data for process 60 on future electronic entertainment item releases. In this way, the system creates an adaptive, self-learning feedback loop.

Video Game Rental Service Overview

Potential video-game renters visit a web site, and register to become a member of an online video game rental subscription service. Upon registration, the new member browses the online listing of video game inventory available for rent, and creates a list of video games that they wish to play. This list of games is a game rental Q, referred to as the “Game Q” (FIG. 31).

Based on analysis of the Game Q for all members, the service is able to write appropriate wholesale purchase orders for games. The quantities of individual games purchased are determined by the preferences expressed by members in their Game Qs. Purchase orders are received into a central inventory, and constitute an inflow of games to the service.

Members, in return for paying a monthly subscription fee, are mailed games from their Game Q. Typically, members are on a 2-game plan, and this entitles them to have two rental games from their Game Q in their possession. Members are entitled to have their games out for any length of time—there are no due dates or late fees. When members receive a game in the mail, they have the option, at any time while they have the game in their possession, of keeping the game, for a purchase price set by the service. The “keep it” price is visible at the web site. If a member does not keep the game, they simply mail it back to the service when they are finished playing it, in the same envelope in which the game arrived. The member typically pays no shipping or postage costs on the games rented. The monthly subscription fee covers these costs. When a member returns a rented game, the service then sends out the next game available from the member's Game Q. In this way, the subscriber continuously has 2 games out from the service. When a member decides to “keep” a rented game, this constitutes an outflow of a game from the service's central inventory. When a member returns a rented game, this does not result in a change in the service's central inventory.

The web site also lists games for purchase. A member can choose to purchase a game, for the price listed at the web site, whether or not the game is on their Game Q. Non-members, not part of the subscription rental service, can also browse the online game listings and make purchases. This activity is referred to as “buy it.” If a member or a non-member “buys” a game listed at the web site, this results in an outflow of a game from the service's central inventory.

The service's central inventory is increased by wholesale purchases. After a game is purchased wholesale, several things can occur. First, the game can be “on the-shelf” waiting to be rented by a member, or bought by members or non-members. Second, the game can be “rented out”, and in a member's possession. Third, while rented-out to a member, it can be purchased by the member through “keep it”. Fourth, the game can be returned by a member when they are finishing renting it, and added back to the “shelf.” Fifth, a game can be purchased through “buy it.” Every unit purchased wholesale by the service is tracked and is classified as “on-the-shelf”, “rented-out”, purchased through “keep it,” or purchased through “buy it.” There is no change to the service's central inventory when a member rents (“rent it”), then returns a game. The service's central inventory decreases when a member decides to keep a rented game in their possession (“keep it”), or when a member or non-member purchases a game listed at the service's web site (“buy it”).

All games sold through “keep it” and “buy it” are pre-owned games that have already been unsealed from their original packaging and in most cases, already rented and used by members. As such, the prices charged for games are almost always expected to be below the retail price that new, unsealed games sell for at mass-market retailing stores.

At the service's web site, members who have games rented will see buttons next to those games that say “keep it”, and will see the corresponding price they must pay, referred to as the “keep it price.” They typically will see these “keep it” buttons and prices on the web page listing their Game Q, but they may also see these on other web pages. Since they are not rental subscribers, non-members will not see “keep it” buttons and “keep it” prices.

Both members and non-members visiting the web site will see game “product basic” description pages. These pages will have buttons for “rent it” and “buy it,” with a “buy it” price. If a member clicks on “rent it”, the game is added to their Game Q. If a non-member clicks on “rent it,” they are prompted to become a rental subscriber. Both members and non-members can click on “buy it” and purchase any game listed at the web site for the “buy it” price. The game is then mailed to the purchaser. The service's software is designed to allow members and non-members to be charged different prices. For example, a member might be charged a lower price than a non-member in order to provide additional incentives for non-members to become members of the service.

FIG. 32 shows the Game Q page that a member will see, with keep it buttons and keep it prices. FIG. 31 shows a game “product basic” description page, with a rent-it button, buy-it button, and corresponding buy-it price.

Overview of Video Game Rental Demand Patterns

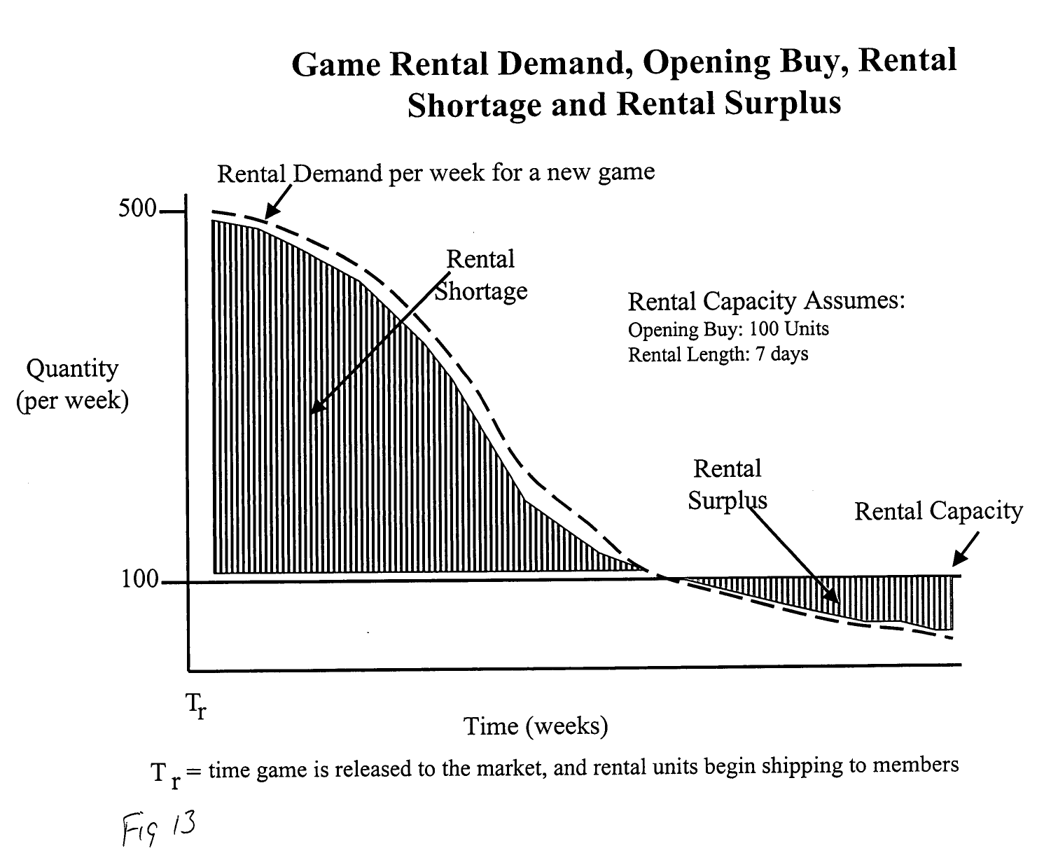

Video game publishers release new video games to the public throughout the year. When a new game is first released it is in high demand—consumers both buy and rent the game in large quantities. As time passes, demand for a game falls, often quite steeply, as interested consumers finish buying and renting the game, and as new game releases displace demand for old games. This pattern of demand presents challenges for video game rental services. It is not possible to place wholesale purchases for enough games to satisfy initial rental demand, creating a significant shortage of games for rent (See “rental shortage” on FIG. 13). If a game rental service purchases enough units of a new game to satisfy initial rental demand, the service is left with too many units as demand falls, creating a “rental surplus.” To minimize the rental surplus, game rental services buy a small number of units (the “opening buy”) relative to initial rental demand. In this way, as demand falls, the service is left with only a small rental surplus (FIG. 13). The result is, the game rental service typically has no games on the shelf for a long period of time, and many customers who wish to rent games are not able to do so. Later in time, when rental demand begins to fall, and daily demand is low enough, some of the games purchased wholesale begin to sit on the shelf-but this rental surplus is small due to the low opening buy.

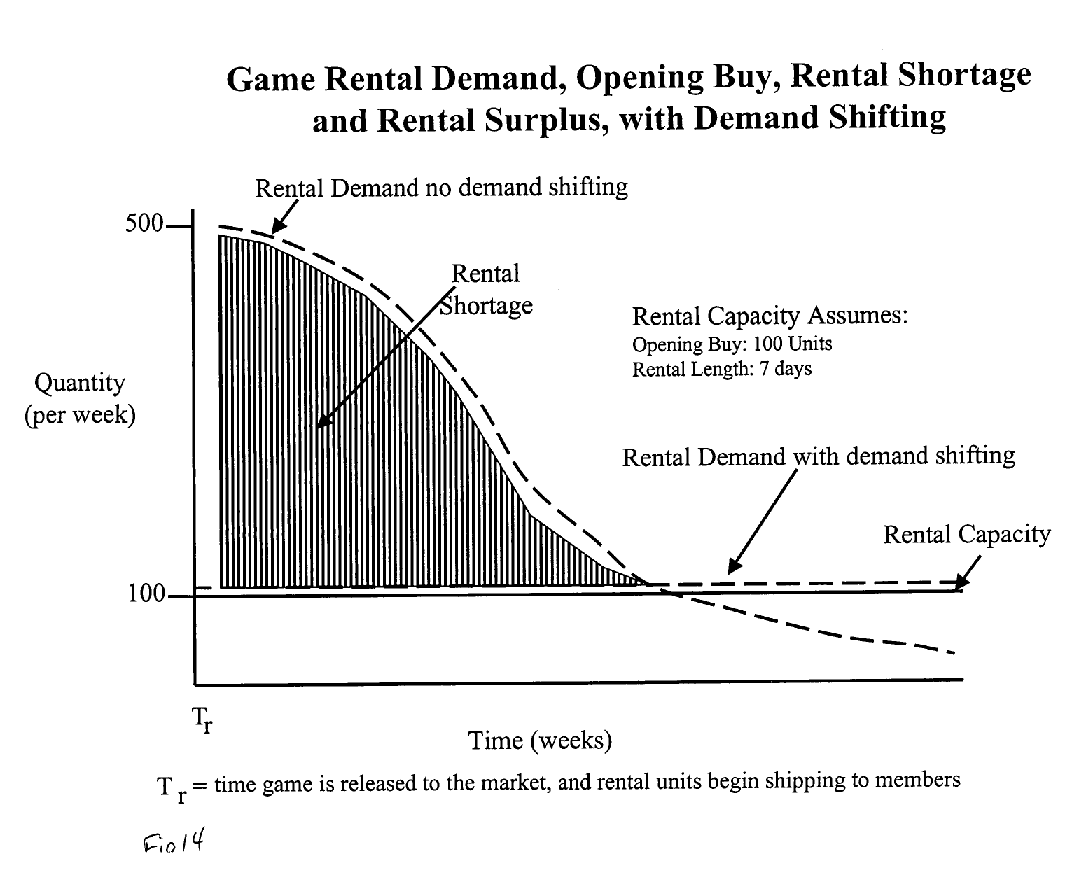

Two factors determine how much rental demand can be satisfied: first, the size of the opening-buy and second, the number of days the rental unit is in the customer's hands. For example, some store-based game rental services offer 7-day rental periods. For every 100 units of a game title purchased wholesale, such a service on average can accommodate just over 14 rentals per day (100 units divided by 7 days), or 100 rentals per week. In FIG. 13, the new game has opening demand in its first week of 1,000 units. The rental service only purchased wholesale 100 units, and offers 7 day rentals. The service therefore has capacity to handle, on average, only 100 rentals per week, and has a significant rental shortage for quite some period of time. The shortage and surplus represented in FIG. 13 assume that unmet demand during the rental shortage period is not shifted-it is lost forever. If unmet demand was shifted, this means customers wait and keep revisiting the store, and their demand is redistributed and flattened (FIG. 14). To the extent demand shifting occurs, this serves to forestall the onset of a rental surplus.

System to Manage Peak Video Game Rental Demand

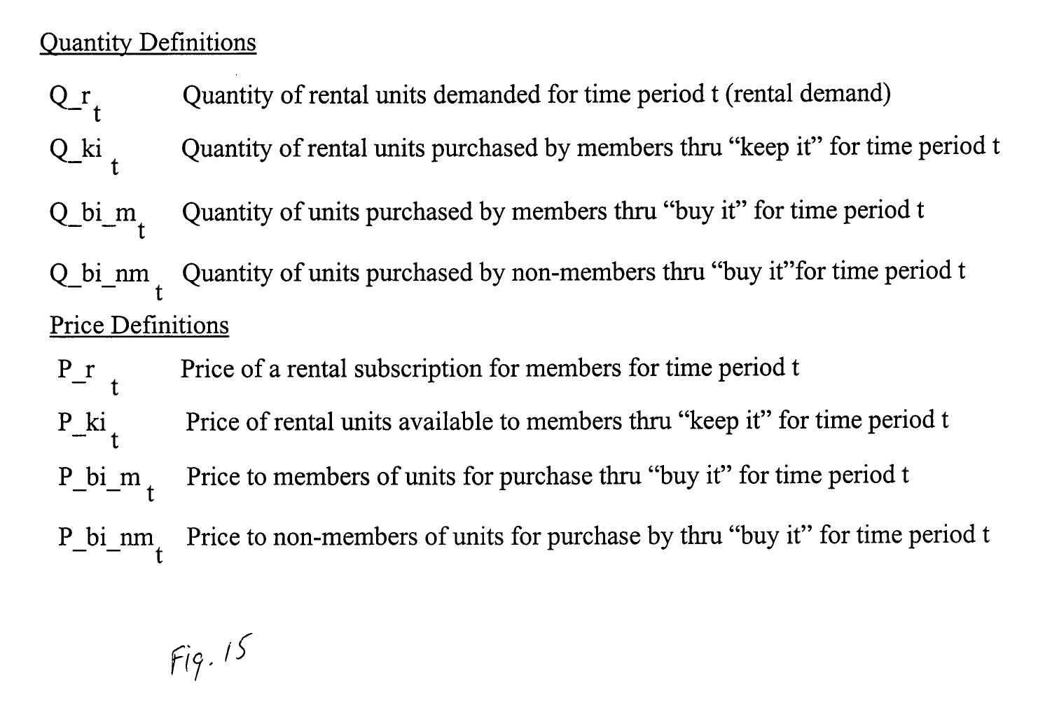

FIG. 15 lists notations and definitions of variables critical to the delivery of the service. They are:

Rental Demand

Quantity of rental units demanded by members (Q_r)

Price to members of a rental subscription (P_r)

Keep-it

Quantity of rental units purchased by members through “keep it” (Q_ki)

Prices charged for “keep it” purchases (P_ki)

Buy-it

Quantity of units purchased through “buy it”, for both members (Q_bi_m) and non-members (Q_bi_nm)

Prices charged for “buy it” purchases. Prices may vary for members (P_bi_m) and non-members (P_bi_nm)

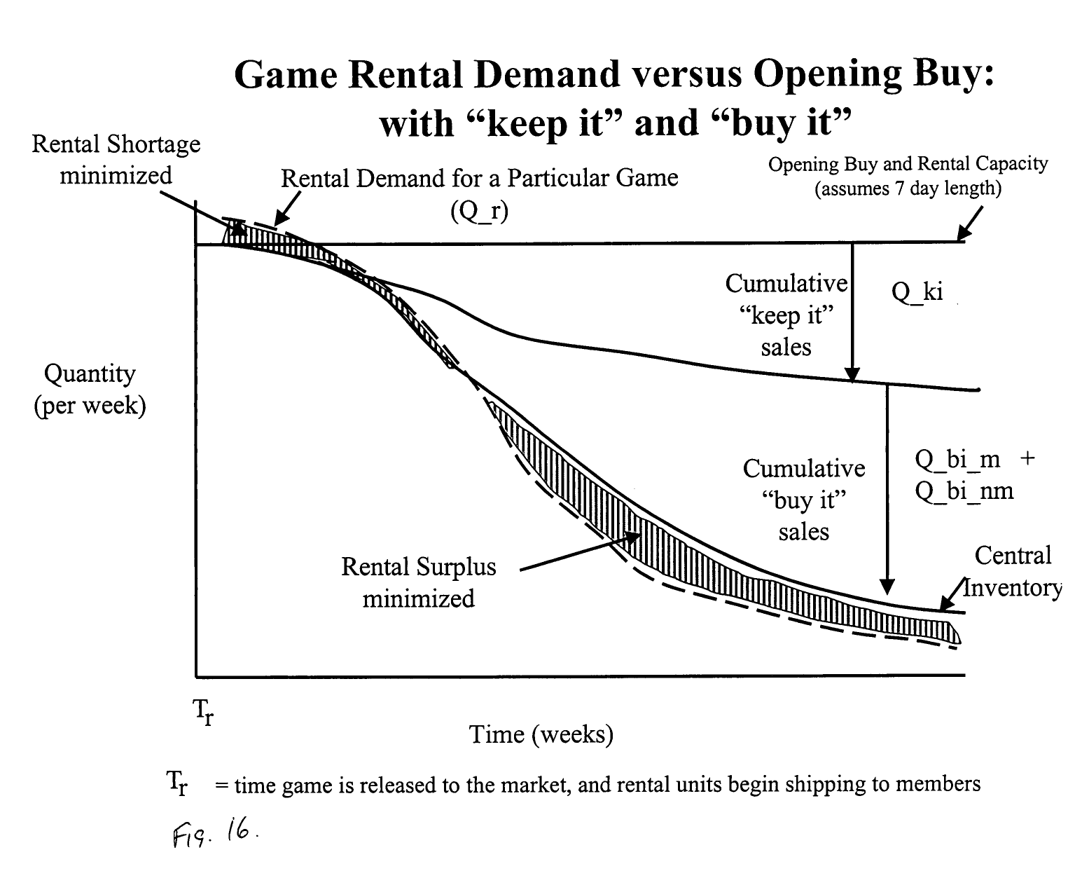

FIG. 16 provides a visual overview of how the system manages video game peak rental demand. The system allows the service to purchase an opening buy quantity of a new game, when it is released, that provides rental capacity at or near the level of opening rental demand. This serves to minimize the rental shortage.

As rental demand falls over time, the system increases cumulative sales of game units through the “keep it” and “buy it” functionality. In this way, the central inventory is continuously reduced after a game's release, to balance it with falling rental demand. This serves to minimize the rental surplus.

The system uses pricing as its primary lever to adjust “keep it” and “buy it” sales. As time passes, and rental demand falls, “keep it” and “buy it” prices typically are reduced to increase the attractiveness of sales, and continue the process of reducing the central inventory.

Detailed System Description

The system is designed around each individual video game released into the market. Below is a step-by-step description of how the system manages a new video game release throughout a game's entire life cycle.

Step 1

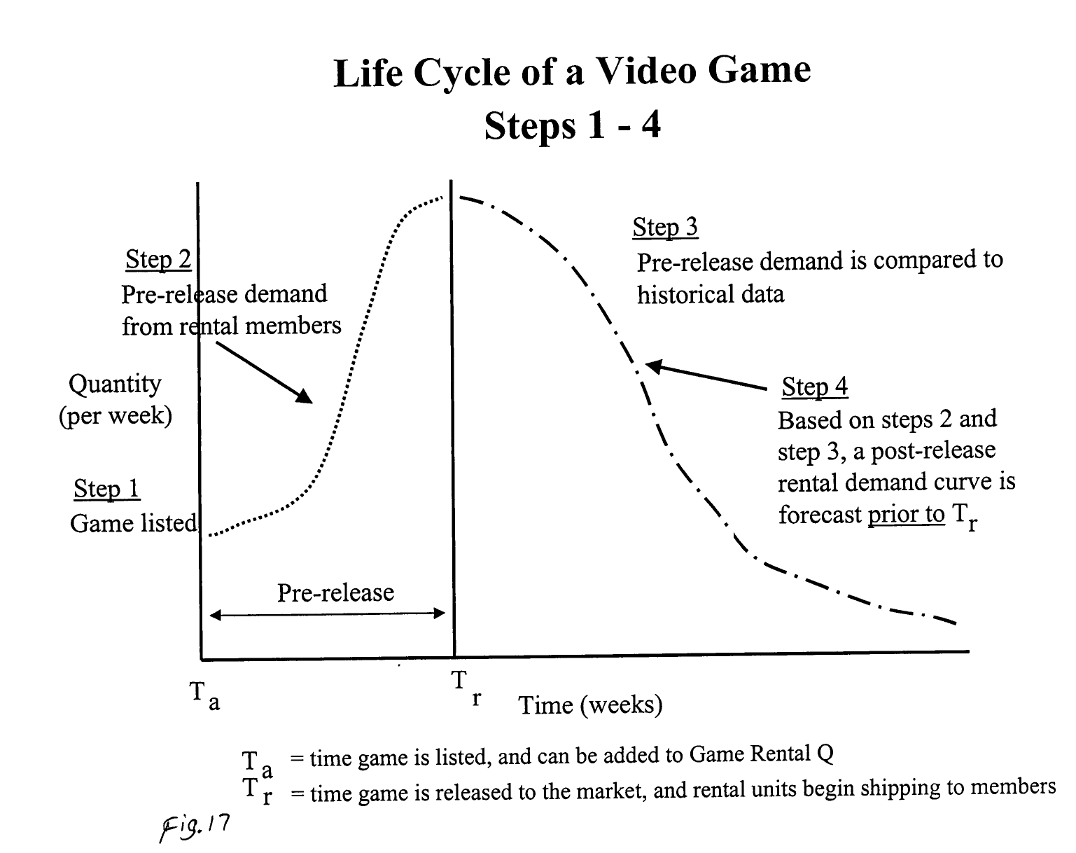

A new game is listed at the service's web site prior to its release to the market. The time of the listing is denoted by T(a). At this point in time, no wholesale purchase orders have been placed for the game by the service. The amount of time between T(a) and the time a game is released to the market, denoted by T(r), varies but is generally 1 to 3 months (see FIG. 17).

Step 2

During the time period between T(a) and T(r), members can add the game to their Game Q. The earlier they do so, and the higher they place the game on their Game Q, the higher the member's priority to receive the first available rental shipments when the game is released. This encourages members to add games to their Game Q prior to a game's release. As members add the game to their Game Q, the level of pre-release rental demand is measured on a continual basis. This derives the pre-release rental demand curve (FIG. 17).

Step 3

The pre-release rental demand curve is compared statistically with historical data on past games. Past games with similar characteristics and similar pre-release rental demand curves are selected as comparables. These comparables are analyzed to see how their post-release rental demand evolved, as well as post-release “keep-it” and “buy-it” sales. An example would be “Madden 2003”, a football themed game. Madden 2003 is compared to prior Madden releases (e.g. “Madden 2002”) and other football and sports games among past releases.

Step 4

A post-release rental demand curve is forecast for the game. This curve estimates the number of rental units that members will demand at a game's release date, and through time thereafter (FIG. 17).

The forecasting process looks at two main data inputs. First, the number of members who have the game within the top 4 slots on their Game Q (this input can be adjusted, e.g. to top 3, to top 6, etc.) prior to a game's release. Second, how this level of “top 4 slot demand” translates to, or spreads to, a weekly demand-pattern. Because a member must return a game in order to have the next game on their Q mailed, and because most members will have a 2-game plan, only a portion of the top 4 slot demand will translate into actual demand for the new game in a given week. For example, the week a new game is released, 100 members might have a game listed within the top 4 sots on their Game Q, but a “spread factor” might be forecast at 42%. In this case, the first week a game is released would see rental demand of 42 units (“top 4 slot demand” multiplied by the “spread factor”).

The forecasting process looks at historical data on prior game releases (step 3) to estimate how a new game's prerelease “top 4 slot demand” will translate to post-release “top 4 slot demand”, and a post-release “spread factor.” As the release date approaches, this forecast is continually updated, as prerelease rental demand data updates.

Step 5

A detailed inventory management plan (IMP) is developed for the game. The IMP sets the initial purchase order quantity, or “opening buy,” and projects the expected length of rental (using historical analysis-step 3). The IMP projects a plan for “keep it” prices and quantities, and “buy it” prices and quantities, over time. The IMP balances these plan variables to minimize the projected rental shortage in the early period after a release, and minimize the projected rental surplus in later time periods. The IMP is generally first developed 1-2 months prior to a game's release date, and is regularly regenerated, as new data is collected.

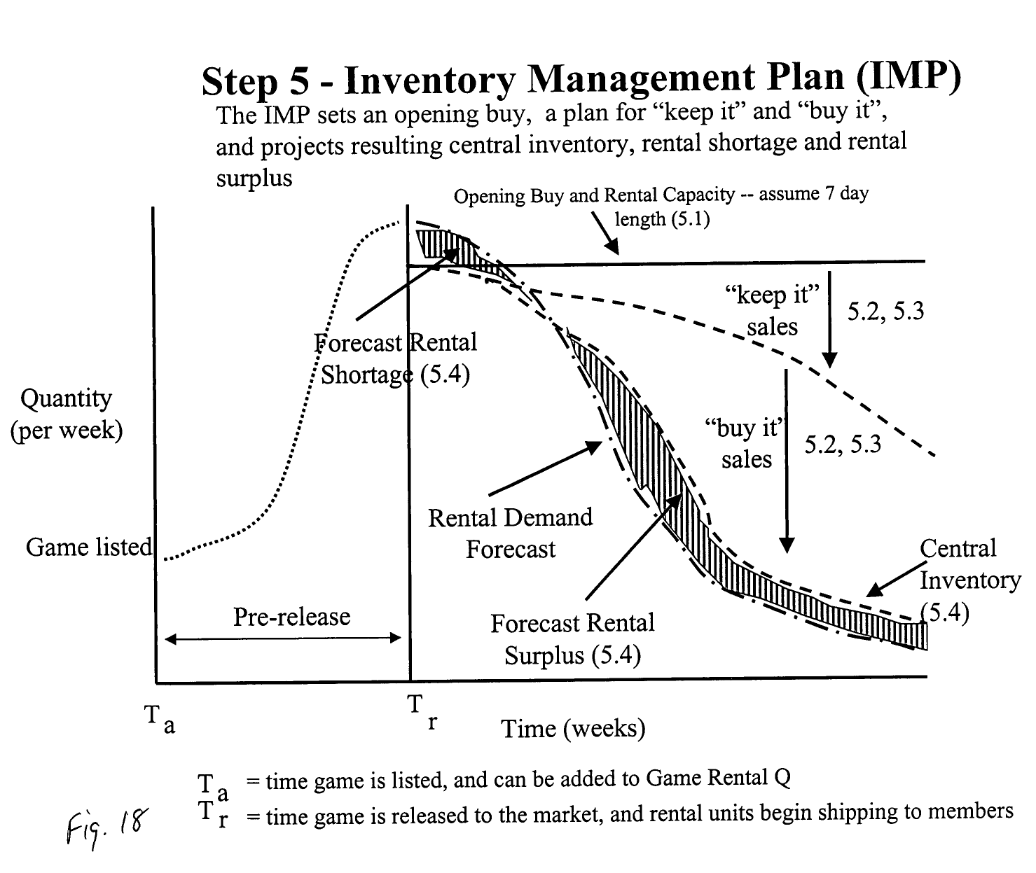

Step 5.1—As the release date approaches, generally within 1 month, the IMP, using the forecast post-release rental demand curve (step 4) and the historical comparables data analysis (step 3), generates an “opening buy” purchase order, projects length of rental, and calculates rental capacity (FIG. 18).

Step 5.2—The IMP generates a plan for “keep it” and “buy it” prices, over time (P_ki, P_bi_m, P_bi_nm, for all time periods). The plan generally reduces these prices over time, as demand for a game subsides.

Step 5.3—Based on forecast post-release rental demand, the opening buy, length of rental, and the pricing plan for “keep it” and “buy it”, corresponding quantities of “keep it” and “buy it” unit sales are forecast (Q_ki, Q_bi_m, Q_bi_nm, for all time periods). Cumulative unit sales increase over time, in order to reduce central inventory as demand for a game subsides, and to minimize the resulting rental surplus (FIG. 18).

Step 5.4—Rental shortages and rental surpluses are forecast, based on all the IMP generated parameters. The primary objective of the IMP is to minimize both the rental shortage and the rental surplus. In addition, the IMP estimates profit opportunities from potentially strong demand for “keep it” and “buy it” at prices above wholesale purchase cost. If such opportunity is forecast, the IMP may call for an opening buy larger than rental demand, creating a rental surplus immediately upon a game's release. Conversely, the IMP may forecast extremely weak demand for “keep it” and “buy it”, and may generate a relatively low opening buy, resulting in relatively higher rental shortages immediately upon a game's release.

Step 6

After a game is released, parameters are tracked (“actuals”) and compared to IMP forecast parameters (“forecasts”) on a continual basis. Actuals can vary quite significantly from forecasts, and these variances are continually measured. As variances develop, the IMP regenerates:

Step 6.1—Actual rental demand is measured, and future rental demand is re-forecast.

Step 6.2—Actual “keep it” and “buy it” demand is measured, and future “keep it” and “buy it” demand is re-forecast, using existing IMP planned pricing trajectories.

Step 6.3—The central inventory, rental shortage and/or rental surplus are measured and re-forecast.

Step 6.4—IMP “keep it” and “buy it” prices are adjusted, and new purchase orders can be generated:

Prices adjust upward if central inventory is too small relative to actual and projected rental demand (rental shortage), “keep it” demand and “buy it” demand. In addition, new purchase orders may be placed if projected shortages are large enough, and/or if the IMP projects, based on strong demand, incremental profit opportunities from additional purchases.

Prices adjust downward if central inventory is too large relative to actual and projected rental demand (rental surplus), “keep it” demand and “buy it” demand.

The magnitude of price adjustments is guided by the magnitude of the variances, the time period in the game's life cycle and comparisons from the historical database. The IMP can also be adjusted based on exogenous data, such as national sales and pricing data collected from 3rd party sources.

Step 7

The games actual IMP parameters (“actuals”) are added to the historical database, and add to the statistical foundation for analyzing and developing IMPs for future releases of new games. Specifically, the historical database, as it accrues data from new game releases, is refined to provide data for steps 3, 4, 5 and 6 on future releases. In this way, the system creates an adaptive, self-learning feedback loop.

Detailed System Example

The system is designed around each individual video game released into the market. Below is a step-by-step description of how the system manages a new video game release throughout a game's entire life cycle.

Step 1 (Detailed Example)

A new game is listed at the service's web site prior to its release to the market. The time of the listing is denoted by T(a). In FIG. 5, T(a) is week (−8). This means the new game is listed at the web site 8 weeks before it will be released. At this point in time, no wholesale purchase orders have been placed for the game by the service.

Step 2 (detailed example)

During the time period between week T(a) and T(r), members can add the game to their Game Q. The earlier they do so, and the higher they place the game on their Game Q, the higher the member's priority to receive the first available rental shipments when the game is released. This encourages members to add games to their Game Q prior to a game's release. As members add the game to their Game Q, the level of pre-release rental demand is measured on a continual basis. This derives the pre-release rental demand curve.

In FIG. 5, pre-release demand builds from week (−8) through to the week before release, or week (−1). Q demand is measured by looking at the top 4 slots. In FIG. 5, by week (−1) 305 members have placed the new game on their Q within the top 4 slots, indicating they are quite interested in receiving the game when it is released. The “spread factor” is estimated from historical averages, in this case projected to be 42%. Based on “top 4 slot demand” of 305 and a “spread factor” of 42%, rental demand in the first week of the game's release is projected to be 128 units (305×42%). This figure is within the column labeled “demand (no shifting).” Demand changes week to week as members add the new game to their Q, and the game works its way up their Q, and as some members choose to delete the game from their Q.

Step 3 (Detailed Example)

The pre-release rental demand curve is compared statistically with historical data on past games. Past games with similar characteristics and similar pre-release rental demand curves are selected as comparables. These comparables are analyzed to see how their postrelease rental demand evolved, as well as post-release “keep it” and “buy it” sales. An example would be “Madden 2003”, a football themed game. Madden 2003 is compared to prior Madden releases (e.g. “Madden 2002”) and other football and sports games among past releases.

The historical database allows any particular game from the past, or group of games, to be analyzed. Some examples of groupings that can be chosen:

All Playstation 2 games

All Sports Games

All Football themed games

All past releases of “Madden”

All Playstation 2 games released in November

The chosen comparables are analyzed using regression analysis to ascertain the statistical correlation between their pre-release demand pattern and subsequent post-release actual demand patterns. These correlations are used in step 4 below.

Step 4 (Detailed Example)

A post-release rental demand curve is forecast for the game. This curve estimates the number of rental units that members will demand at a game's release date, and through time thereafter (FIG. 17).

The forecasting process looks at two main data inputs. First, the number of members who have the game within the top 4 slots on their Game Q (this input can be adjusted, e.g. to top 3, to top 6, etc.) prior to a game's release. Second, how this level of “top 4 slot demand” translates to, or spreads to, a weekly demand-pattern. Because a member must return a game in order to have the next game on their Q mailed, and because most members will have a 2-game plan, on a portion of the top 4 slot demand will translate into actual demand for the new game in a given week. For example, the week a new game is released, 100 members might have a game listed within the top 4 sots on their Game Q, but a “spread factor” might be forecast at 42%. In this case, the first week a game is released would see rental demand of 42 units (“top 4 slot demand” multiplied by the “spread factor”).

The forecasting process looks at historical data on prior game releases (step 3) to estimate how a new game's pre-release “top 4 slot demand” will translate to post-release “top 4 slot demand”, and a post-release “spread factor.” As the release date approaches, this forecast is continually updated, as pre-release rental demand data updates.

In FIG. 6, based on the comparables analysis, a post-release rental demand curve is projected. This is the column titled “demand (no shifting)” from weeks 1 through 27. The first week, week (1), takes the projection of 128 units rental demand (see step 2 above), and assumes inventory will be available to ship all 128 members a copy of the game. “Top 4 slot demand” in week (1) is then projected as follows:

Top 4 slot demand week (−1) minus Demand week (1) plus Additions week (1) minus Deletions week (1)

Which equals:

305−128+44−6=215

This new “top 4 slot demand” in the Q is then applied against the spread factor of 40%, to arrive at week (2) rental demand of 86 units (215×40%=86). This process repeats itself for each week through week (27).

At this point in the process, the column “demand (with shifting)” is equal to the column “demand (no shifting)”. It is assumed, at this point in the IMP process that there will be sufficient inventory to ship every unit of rental demand.

Step 5 (Detailed Example)

A detailed inventory management plan (IMP) is developed for the game. The IMP sets the initial purchase order quantity, or “opening buy,” and projects the expected length of rental (using historical analysis-step 3). The IMP projects a plan for “keep it” prices and quantities, and “buy it” prices and quantities, over time. The IMP balances these plan variables to minimize the projected rental shortage in the early period after a release, and minimize the projected rental surplus in later time periods. The IMP is generally first developed 1-2 months prior to a game's release date, and is regularly regenerated, as new data is collected.

Step 5.1—As the release date approaches, generally within 1 month, the IMP, using the forecast post-release rental demand curve (step 4) and the historical comparables data analysis (step 3), generates an “opening buy” purchase order, projects length of rental, and calculates rental capacity. In FIG. 7, with the IMP chooses an opening buy of 128 units, forecasts a rental length of 7 days, and determines an average weekly rental capacity of 128 units. The IMP model can handle a statistical distribution of rental lengths, but in this example, 100% of rentals are forecast at 1-week (7 days) duration. In FIG. 7, the IMP calculates the “fill rate” for each week, and in this example, the fill rate is 100% for each week from week (1) through week (27). This means that 100% of member rental demand is met, for each week post-release.

At this point, no “keep it” or “buy it” sales are assumed. In FIG. 7, the rental shortage and surplus are forecast, and the number of game units that will sit on the service's “shelf” at the end of each week, is forecast. In FIG. 7, in week (2), this game will be in a rental surplus and 42 units will be on the “shelf.”

Step 5.2—The IMP generates a plan for “keep it” and “buy it” prices, over time (P_ki, P_bi_m, P_bi_nm for all time periods). The plan generally reduces these prices over time as demand for a game subsides.

In FIG. 8, the IMP forecasts “keep it” prices (P_ki) to be $50.00 in week 1, falling to $44.95 in weeks (2) through (3), an prices are slowly decreased over weeks (4) through (27).

The IMP forecasts “buy it” prices (P_bi_m and P_bi_nm) to start at $50.00 in week 1 and slowly trend down through week (27). In general, the “buy it” price is at least $2.00 above the “keep it” price available to members.

In addition, the system has the ability to allow members to receive a “buy it” price lower than that generally available to non-members. In this example, however, the only 1 “buy it” price is displayed, and members are not receiving this discount.

Step 5.3—Based on forecast post-release rental demand, the opening buy, length of rental, and the pricing plan for “keep it” and “buy it”, corresponding quantities of “keep it” and “buy it” unit sales are forecast (Q_ki, Q_bi_m, Q_bi_nm, for all time periods). Cumulative unit sales increase over time, in order to reduce central inventory as demand for a game subsides, and to minimize the resulting rental surplus.

In FIG. 8, the purchase “rate” for “keep it” and “buy it” is forecast based on the prices in the IMP, and historical regression analysis of “keep it” and “buy it” sales (step 3 analysis).

The “keep it” rate is the percentage of rental units out to members that will be purchased through “keep it” at the forecast price in a given time period. For example, in week 5 in FIG. 8 the IMP forecasts the “keep it” rate, given a price of $42.95, to be 10%. Based on the number of rental units projected to ship in week 5, this translates to 5 units purchased in week (5) by members through “keep it.”

The “buy it” rate is the percentage of rental units on the “shelf” that will be purchased by members and non-members through “buy it” at the forecast price in a given time period. For example, in week 5 in FIG. 8 the IMP forecasts the “buy it” rate, given a price of $44.95, to be 8%. Based on the number of rental units on the shelf in week 5, this translates to 4 units purchased in week 5 through “buy it.” The system does not list units with a “buy it” button on the web site if there are no rental units on the “shelf.” In week 1, despite a “buy it” rate forecast of 4%, the “stock adjusted” rate is 0%, since no units are forecast to be on the shelf.

By week (27), the IMP plan forecasts 69 units of the original opening buy of 128 units will be sold to members through “keep it”. By week (27), the IMP plan forecasts 57 units will be sold to members and non-members through “buy it.”

Step 5.4—Rental shortages and rental surpluses are forecast, based on all the IMP generated parameters. The primary objective of the IMP is to minimize both the rental shortage and the rental surplus. In addition, the IMP estimates profit opportunities from potentially strong demand for “keep it” and “buy it” at prices above wholesale purchase cost. If such opportunity is forecast, the IMP may call for an opening buy larger than rental demand, creating a rental surplus immediately upon a game's release. Conversely, the IMP may forecast extremely weak demand for “keep it” and “buy it”, and may generate a relatively low opening buy, resulting in relatively higher rental shortages immediately upon a game's release.

In the detailed example, FIG. 9 shows that screen 2A is regenerated, based on the “keep it” and “buy it” plans, as screen 2B. This screen reflects that some rental units are not returned, and some units on the shelf are sold off. By week (27) The IMP forecasts that, with projected “keep it” and “buy it” sales, there will be no rental surplus.

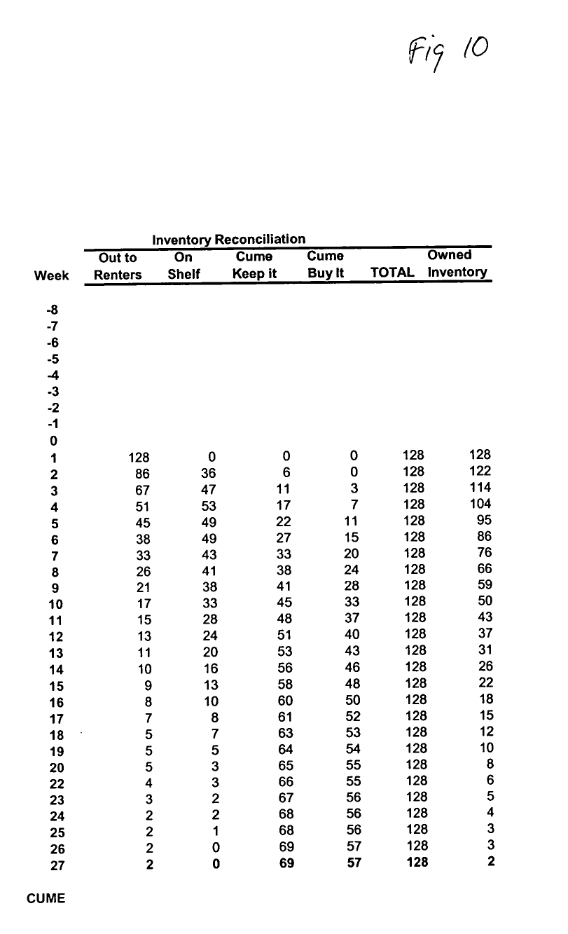

FIG. 10 shows the IMP's forecast inventory reconciliation (screen 4). In screen 4, the opening buy of 128 units is reconciled for each week through week (27). For example, by week 10, 17 units are out to rental members, 34 units are “on the shelf,” 45 units have been sold to members through “keep it,” and 31 units have been sold through “buy it.” This accounts for all 128 units of the opening buy (note, figures in these examples are subject to rounding error).

Step 6 (Detailed Example)

After a game is released, parameters are tracked (“actuals”) and compared to IMP forecast parameters (“forecasts”) on a continual basis. Actuals can vary quite significantly from forecasts, and these variances are continually measured. As variances develop, the IMP regenerates:

Step 6.1—Actual rental demand is measured, and future rental demand is re-forecast.

Step 6.2—Actual “keep it” and “buy it” demand is measured, and future “keep it” and “buy it” demand is re-forecast, using existing IMP planned pricing trajectories.

Step 6.3—The central inventory, rental shortage and/or rental surplus are measured and re-forecast.

Step 6.4—IMP “keep it” and “buy it” prices are adjusted, and new purchase orders can be generated:

Prices adjust upward if central inventory is too small relative to actual and projected rental demand (rental shortage), “keep it” demand and “buy it” demand. In addition, new purchase orders may be placed if projected shortages are large enough, and/or if the IMP projects, based on strong demand, incremental profit opportunities from additional purchases.

Prices adjust downward if central inventory is too large relative to actual and projected rental demand (rental surplus), “keep it” demand and “buy it” demand.

The magnitude of price adjustments is guided by the magnitude of the variances, the time period in the game's life cycle and comparisons from the historical database. The IMP can also be adjusted based on exogenous data, such as national sales and pricing data collected from 3rd party sources.

Step 7 (Detailed Example)

The games actual IMP parameters (“actuals”) are added to the historical database, and add to the statistical foundation for analyzing and developing IMPs for future releases of new games. Specifically, the historical database, as it accrues data from new game releases, is refined to provide data for steps 3, 4, 5 and 6 on future releases. In this way, the system creates an adaptive, self-learning feedback loop.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What we claim:

1. A method for managing inventory level of electronic media rental units, said method comprising the steps of:
listing for future rental of an electronic media prior to the general public release date of said electronic media;
receiving placement of orders for future rental of said electronic media;
determining pre-release rental demand for said electronic media; and
determining a post-release rental demand for rental units of said electronic media.

2. The method of claim 1, further comprising the step of determining a correlation relationship between the pre-release rental demand of said electronic media and a pre-release rental demand of a previously released electronic media.

3. The method of claim 1, further comprising the step of determining a post-release sales demand for rental units of said electronic media.

4. The method of claim 1, wherein said electronic media is listed over the Internet, and wherein said placement of orders is received over the Internet.

5. The method of claim 1, further comprising the step of determining a life cycle of said electronic media.

6. The method of claim 1, further comprising the step of listing for sale said electronic media.

7. The method of claim 1, further comprising the step of determining a spread factor of the post-release rental demand for said electronic media.

8. The method of claim 1, further comprising the step of determining the quantity of an initial purchase order of said electronic media rental units.

9. The method of claim 1, further comprising the step of determining a future sales quantity of said electronic media rental units.

10. The method of claim 1, further comprising the step of determining a future sales price of said electronic media rental units.

11. The method of claim 10, further comprising the step of periodically adjusting said sales price of said electronic media rental units.

12. The method of claim 11, wherein the monetary amount of each periodic price adjustment is the same.

13. The method of claim 1, further comprising the steps of determining rental surplus or shortage of said electronic media rental units.

14. The method of claim 1, further comprising the step of tracking an actual rental demand of said electronic media rental units after the electronic media is released to the general public.

15. The method of claim 3, further comprising the step of tracking an actual sales demand of said electronic media rental units after the electronic media is released to the general public.

16. The method of claim 1, further comprising the step of determining the quantity of a subsequent purchase order of said electronic media rental units.

17. The method of claim 1, further comprising the step of determining updated future rental demand of said electronic media rental units.

18. A method of managing distribution of electronic media units to a plurality of registered members of a user group, said method comprising the steps of:
listing for future rental an electronic media prior to a release date of said electronic media;
receiving from one of said plurality of registered members a placement of order for future rental of said electronic media, said one registered member placing said order in an ordering queue, said ordering queue including an array of order selection slots for designating different electronic media to be ordered for rental by said one registered member; and
distributing to said one registered member a unit of said electronic media upon or after the release date.

19. The method of claim 18, further comprising the step of assigning a priority status to said placement of order, said priority status being assigned in accordance with a timing at which the placement of order was received

20. The method of claim 18, wherein said unit of said electronic media is distributed to said one registered member via the Internet.

21. The method of claim 18, further comprising the step of offering to said one registered member the option to purchase the distributed unit of said electronic media unit.

22. The method of claim 18, further comprising the step of offering for future sale units of the listed electronic media.

23. The method of claim 22, further comprising the step of offering to the registered members discounts off of a purchase price.

24. The method of claim 18, further comprising the steps of:
determining pre-release rental demand for said electronic media;
calculating correlation characteristics between the pre-release rental demand of said electronic media with a pre-release rental demand of a previously released electronic media; and
determining a post-release rental demand for units of said electronic media.

25. The method of claim 24, further comprising the step of determining a post-release sales demand for units of said electronic media.

26. The method of claim 24, further comprising the step of tracking actual rental demand of the electronic media after its release date.

27. The method of claim 26, further comprising the step of determining an updated future rental demand of said electronic media units.

28. The method of claim 24, further comprising the step of determining a quantity of an initial purchase order of said electronic media units.

29. The method of claim 24, further comprising the step of determining a future rental surplus or shortage of said electronic media units.

30. A machine-readable medium including a set of executable instructions for causing a processor to perform a method of managing inventory level of electronic media rental units, said method comprising the steps of:
listing for future rental of an electronic media prior to the general public release date of said electronic media;
receiving placement of orders for future rental of said electronic media;
determining pre-release rental demand for said electronic media; and
determining a post-release rental demand for rental units of said electronic media.

31. A machine-readable medium including a set of executable instructions for causing a processor to perform a method of managing distribution of electronic media units to a plurality of registered members of a user group, said method comprising the steps of:
listing for future rental an electronic media prior to a release date of said electronic media;
receiving from one of said plurality of registered members a placement of order for future rental of said electronic media, said one registered member placing said order in an ordering queue, said ordering queue including an array of order selection slots for designating different electronic media to be ordered for rental by said one registered member; and
distributing to said one registered member a unit of said electronic media upon or after the release date.
